(19) United States
(12) Patent Application Publication
(10) Pub. No.: US 2025/0093947 A1
(43) Pub. Date: Mar. 20, 2025

(54) USER INTERFACES FOR OBJECT DETECTION

(71) Applicant: Apple Inc., Cupertino, CA (US)

(72) Inventors: Noah D. BEDARD, Los Gatos, CA (US); Julian QUINTANA, San Diego, CA (US); Ethan T. DANIELS, Los Gatos, CA (US); Ting SUN, Cupertino, CA (US); Kathrin Berkner CIESLICKI, Los Altos, CA (US); John S. KERR, Healdsburg, CA (US); Chad A. BRONSTEIN, Los Altos, CA (US); Mahmut C. ORSAN, Mountain View, CA (US); Eugene Y. KIM, San Francisco, CA (US); Molly J. ANDERSON, San Francisco, CA (US); Seung Wook KIM, San Jose, CA (US); Howard TSAI, San Jose, CA (US); Branko PETLJANSKI, Neubiberg (DE)

(21) Appl. No.: 18/778,706

(22) Filed: Jul. 19, 2024

Related U.S. Application Data
(60) Provisional application No. 63/538,749, filed on Sep. 15, 2023.

(51) Int. Cl. G06F 3/01; G04G 9/00; G04G 21/00; G06F 1/3231; G06F 3/0481; G06F 3/0485; G06T 13/80

(52) U.S. Cl. CPC G06F 3/012; G04G 9/007; G04G 21/00; G06F 1/3231; G06F 3/013; G06F 3/0481; G06F 3/0485; G06T 13/80; G06T 2200/24

(57) ABSTRACT

The present disclosure generally relates to updating user interfaces based on user presence and/or outputting information about detected real-world object.

### CROSS-REFERENCE TO RELATED APPLICATIONS

This application claims priority to U.S. Provisional Patent Application No. 63/538,749, entitled “USER INTERFACES FOR OBJECT DETECTION,” filed on Sep. 15, 2023, the content of which is hereby incorporated by reference in its entirety.

### FIELD

The present disclosure relates generally to computer user interfaces, and more specifically to user interfaces based on object detection.

### BACKGROUND

Detecting the presence of a user enables computer systems to perform various tasks, such as facial recognition. Computer systems also optionally detect and identify objects using cameras.

### BRIEF SUMMARY

Some techniques using object detection with electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces that are based on object detection. Such methods and interfaces optionally complement or replace other methods that use object detection. Such methods and interfaces reduce the cognitive burden on a user and produce a more efficient human-machine interface. For battery-operated computing devices, such methods and interfaces conserve power and increase the time between battery charges.

In some embodiments, a method is disclosed. The method comprises: at a computer system that is in communication with one or more input devices and one or more display generation components: while displaying, via the one or more display generation components, a user interface: in accordance with a determination that a first set of one or more conditions is met, the first set of one or more conditions including a presence not detected condition that is met when a user presence at the computer system is not detected via the one or more input devices: displaying, via the one or more display generation components, a first user interface object; and/or ceasing display, via the one or more display generation components, of a second user interface object.

In some embodiments, a non-transitory computer-readable storage medium is disclosed. The non-transitory computer-readable storage medium stories one or more programs configured to be executed by one or more processors of a computer system that is in communication with one or more input devices and one or more display generation components, the one or more programs including instructions for: while displaying, via the one or more display generation components, a user interface: in accordance with a determination that a first set of one or more conditions is met, the first set of one or more conditions including a presence not detected condition that is met when a user presence at the computer system is not detected via the one or more input devices: displaying, via the one or more display generation components, a first user interface object; and/or ceasing display, via the one or more display generation components, of a second user interface object.

In some embodiments, a transitory computer-readable storage medium is disclosed. The transitory computer-readable storage medium stories one or more programs configured to be executed by one or more processors of a computer system that is in communication with one or more input devices and one or more display generation components, the one or more programs including instructions for: while displaying, via the one or more display generation components, a user interface: in accordance with a determination that a first set of one or more conditions is met, the first set of one or more conditions including a presence not detected condition that is met when a user presence at the computer system is not detected via the one or more input devices: displaying, via the one or more display generation components, a first user interface object; and/or ceasing display, via the one or more display generation components, of a second user interface object.

In some embodiments, a computer system is disclosed. The computer system is configured to communicate with one or more input devices and one or more display generation components, and comprises: one or more processors; and memory storing one or more programs configured to be executed by the one or more processors, the one or more programs including instructions for: while displaying, via the one or more display generation components, a user interface: in accordance with a determination that a first set of one or more conditions is met, the first set of one or more conditions including a presence not detected condition that is met when a user presence at the computer system is not detected via the one or more input devices: displaying, via the one or more display generation components, a first user interface object; and/or ceasing display, via the one or more display generation components, of a second user interface object.

In some embodiments, a computer system is disclosed. The computer system is configured to communicate with one or more input devices and one or more display generation components, and comprises: means, while displaying, via the one or more display generation components, a user interface, for: in accordance with a determination that a first set of one or more conditions is met, the first set of one or more conditions including a presence not detected condition that is met when a user presence at the computer system is not detected via the one or more input devices: displaying, via the one or more display generation components, a first user interface object; and/or ceasing display, via the one or more display generation components, of a second user interface object.

In some embodiments, a computer program product. The computer program product comprises one or more programs configured to be executed by one or more processors of a computer system that is in communication with one or more input devices and one or more display generation components, the one or more programs including instructions for: while displaying, via the one or more display generation components, a user interface: in accordance with a determination that a first set of one or more conditions is met, the first set of one or more conditions including a presence not detected condition that is met when a user presence at the computer system is not detected via the one or more input devices: displaying, via the one or more display generation components, a first user interface object; and/or ceasing display, via the one or more display generation components, of a second user interface object.

In some embodiments, a method is disclosed. The method comprises: at a computer system that is in communication with one or more input devices that include one or more cameras and one or more output devices that include one or more display generation components: while not displaying, via the one or more display generation components, a camera feed based on the one or more cameras: receiving, via the one or more input devices, a request to scan a real-world object; and in response to receiving the request to scan the real-world object: scanning, via the one or more input devices, the real-world object; and outputting, via the one or more output devices, information about the real-world object.

In some embodiments, a non-transitory computer-readable storage medium is disclosed. The non-transitory computer-readable storage medium stores one or more programs configured to be executed by one or more processors of a computer system that is in communication with one or more input devices that include one or more cameras and one or more output devices that include one or more display generation components, the one or more programs including instructions for: while not displaying, via the one or more display generation components, a camera feed based on the one or more cameras: receiving, via the one or more input devices, a request to scan a real-world object; and in response to receiving the request to scan the real-world object: scanning, via the one or more input devices, the real-world object; and outputting, via the one or more output devices, information about the real-world object.

In some embodiments, a transitory computer-readable storage medium is disclosed. The transitory computer-readable storage medium stores one or more programs configured to be executed by one or more processors of a computer system that is in communication with one or more input devices that include one or more cameras and one or more output devices that include one or more display generation components, the one or more programs including instructions for: while not displaying, via the one or more display generation components, a camera feed based on the one or more cameras: receiving, via the one or more input devices, a request to scan a real-world object; and in response to receiving the request to scan the real-world object: scanning, via the one or more input devices, the real-world object; and outputting, via the one or more output devices, information about the real-world object.

In some embodiments, a computer system is disclosed. The computer system is configured to communicate with one or more input devices that include one or more cameras and one or more output devices that include one or more display generation components, and comprises: one or more processors; and memory storing one or more programs configured to be executed by the one or more processors, the one or more programs including instructions for: while not displaying, via the one or more display generation components, a camera feed based on the one or more cameras: receiving, via the one or more input devices, a request to scan a real-world object; and in response to receiving the request to scan the real-world object: scanning, via the one or more input devices, the real-world object; and outputting, via the one or more output devices, information about the real-world object.

In some embodiments, a computer system is disclosed. The computer system is configured to communicate with one or more input devices that include one or more cameras and one or more output devices that include one or more display generation components, and comprises: means, while not displaying, via the one or more display generation components, a camera feed based on the one or more cameras, for: receiving, via the one or more input devices, a request to scan a real-world object; and in response to receiving the request to scan the real-world object: scanning, via the one or more input devices, the real-world object; and outputting, via the one or more output devices, information about the real-world object.

In some embodiments, a computer program product is disclosed. The computer program product comprises one or more programs configured to be executed by one or more processors of a computer system that is in communication with one or more input devices that include one or more cameras and one or more output devices that include one or more display generation components, the one or more programs including instructions for: while not displaying, via the one or more display generation components, a camera feed based on the one or more cameras: receiving, via the one or more input devices, a request to scan a real-world object; and in response to receiving the request to scan the real-world object: scanning, via the one or more input devices, the real-world object; and outputting, via the one or more output devices, information about the real-world object.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for using object detection, thereby increasing the effectiveness, efficiency, and user satisfaction with such devices. Such methods and interfaces may complement or replace other methods for using object detection.

DESCRIPTION OF THE FIGURES

For a better understanding of the various described embodiments, reference should be made to the Description of Embodiments below, in conjunction with the following drawings in which like reference numerals refer to corresponding parts throughout the figures.

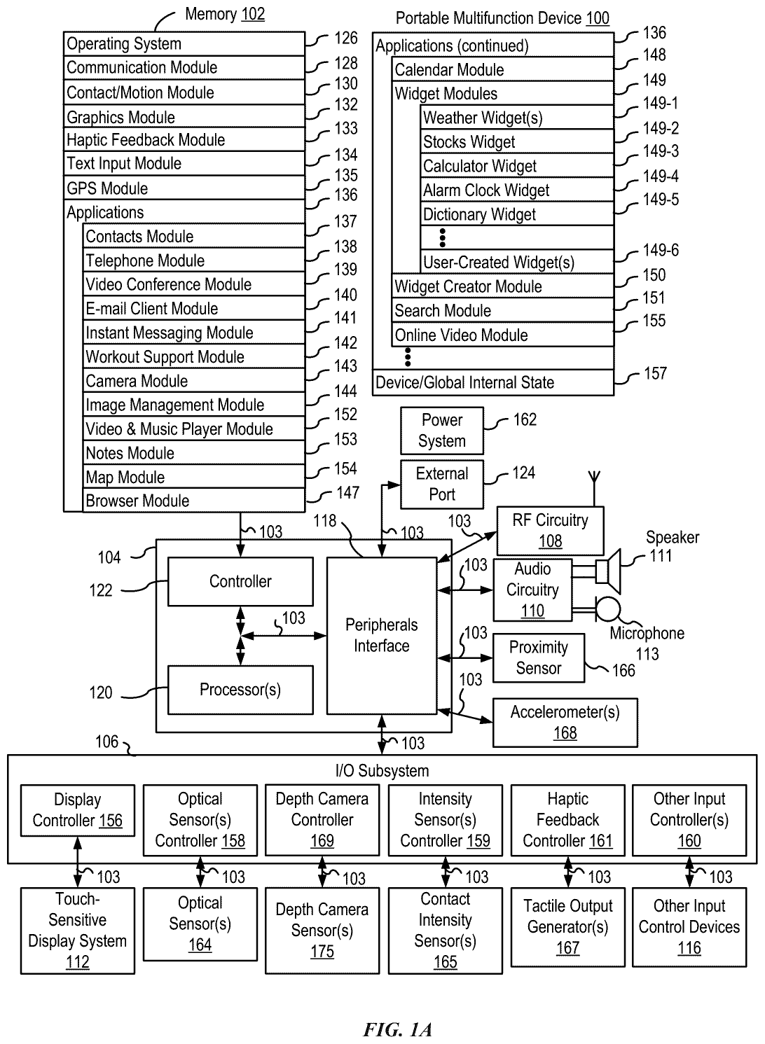

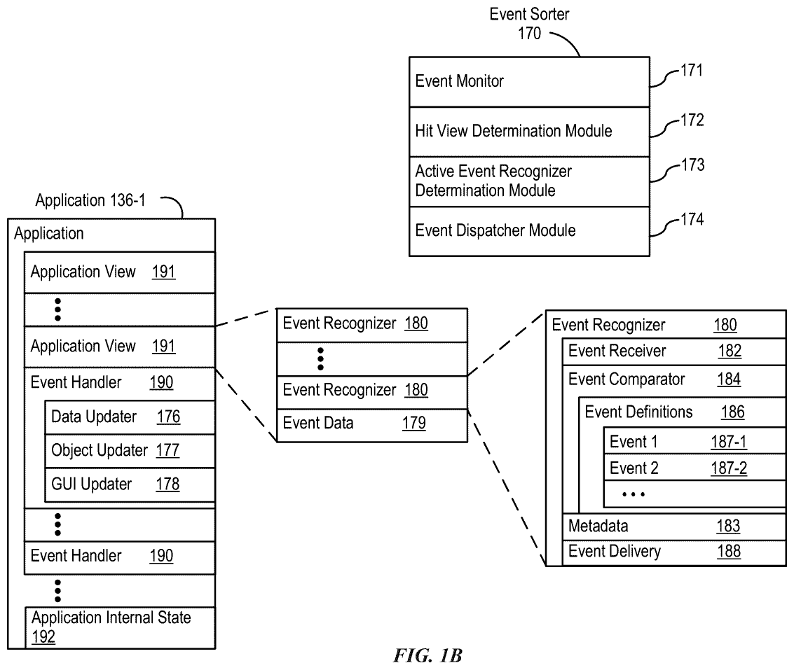

FIG. 1A is a block diagram illustrating a portable multifunction device with a touch-sensitive display in accordance with some embodiments.

FIG. 1B is a block diagram illustrating exemplary components for event handling in accordance with some embodiments.

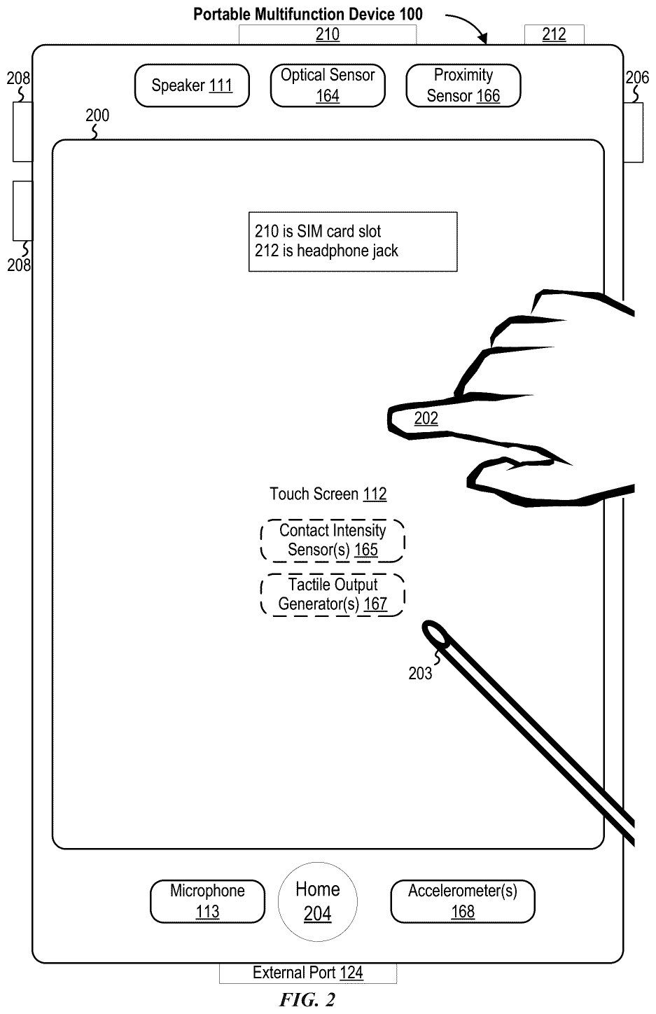

FIG. 2 illustrates a portable multifunction device having a touch screen in accordance with some embodiments.

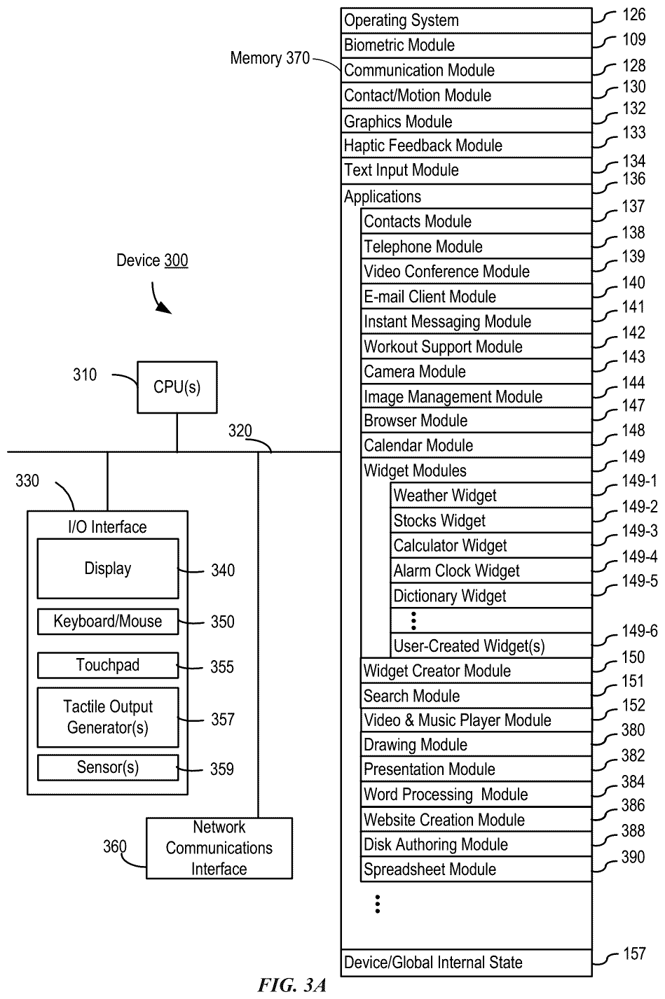

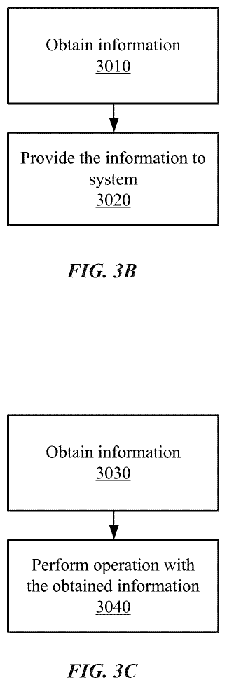

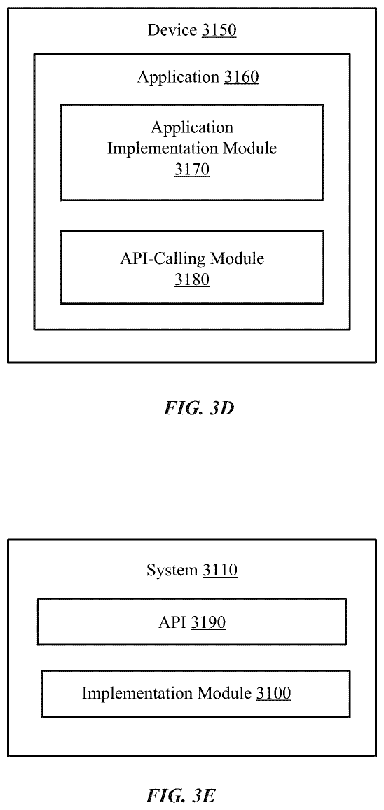

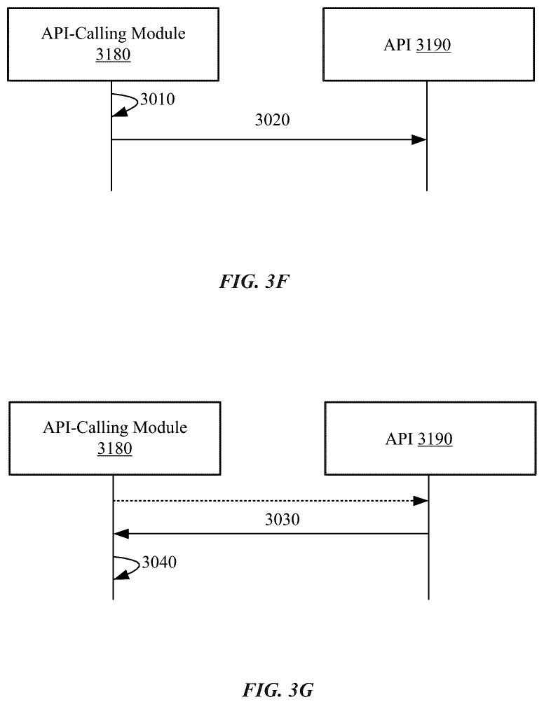

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

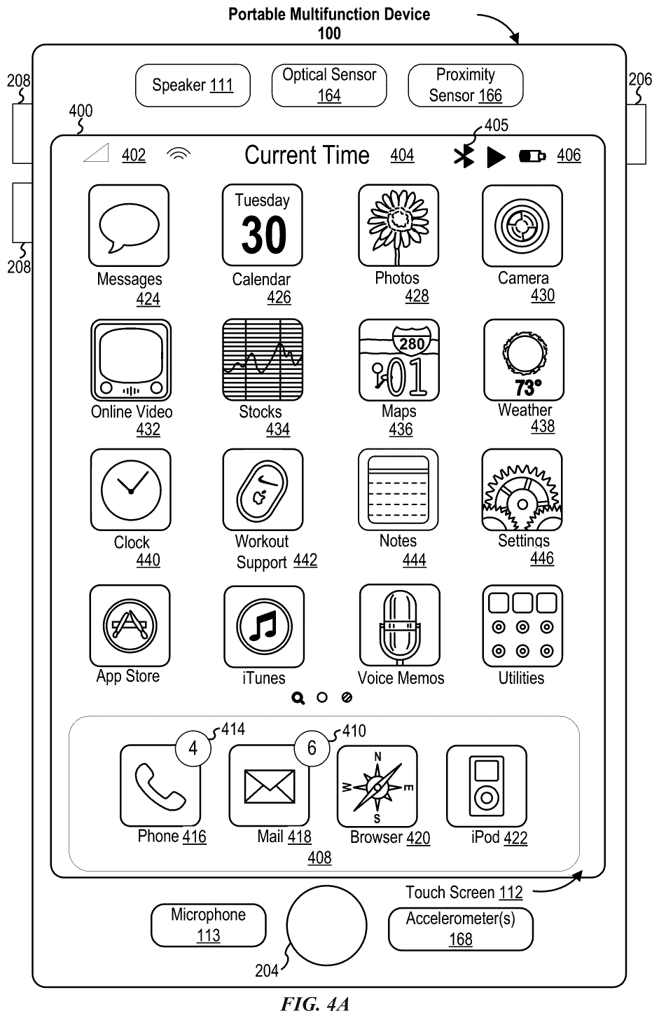

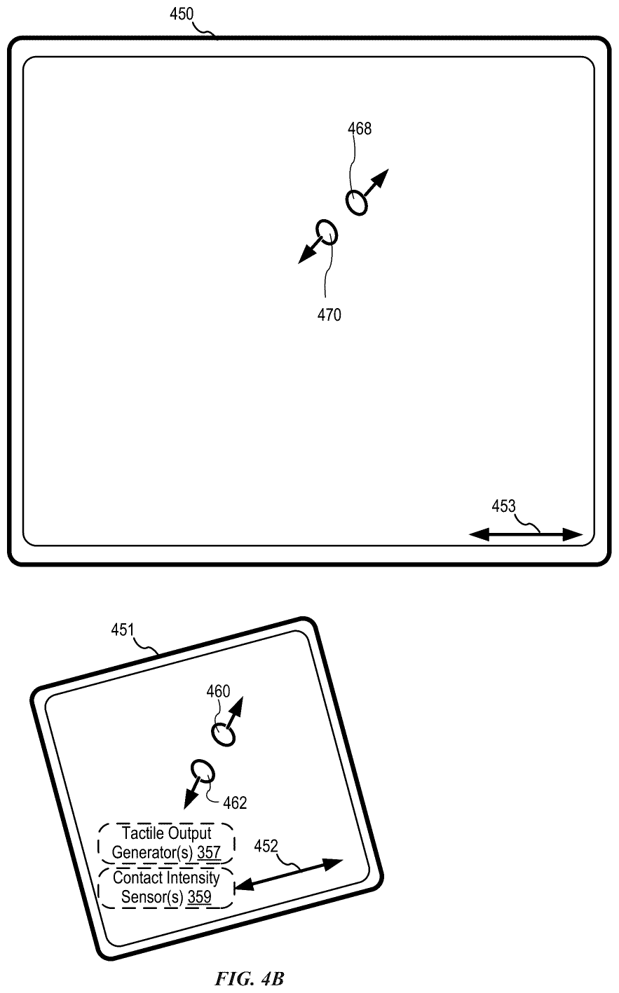

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

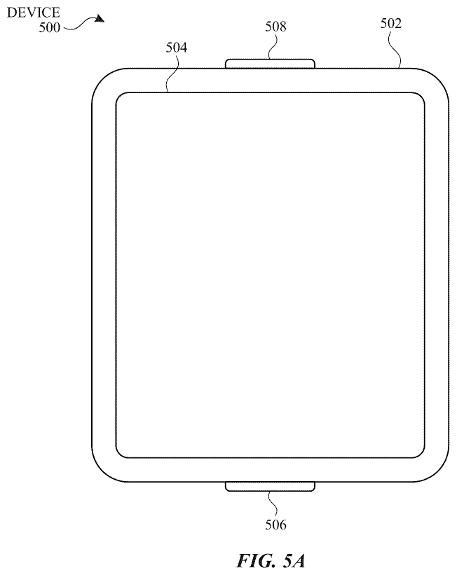

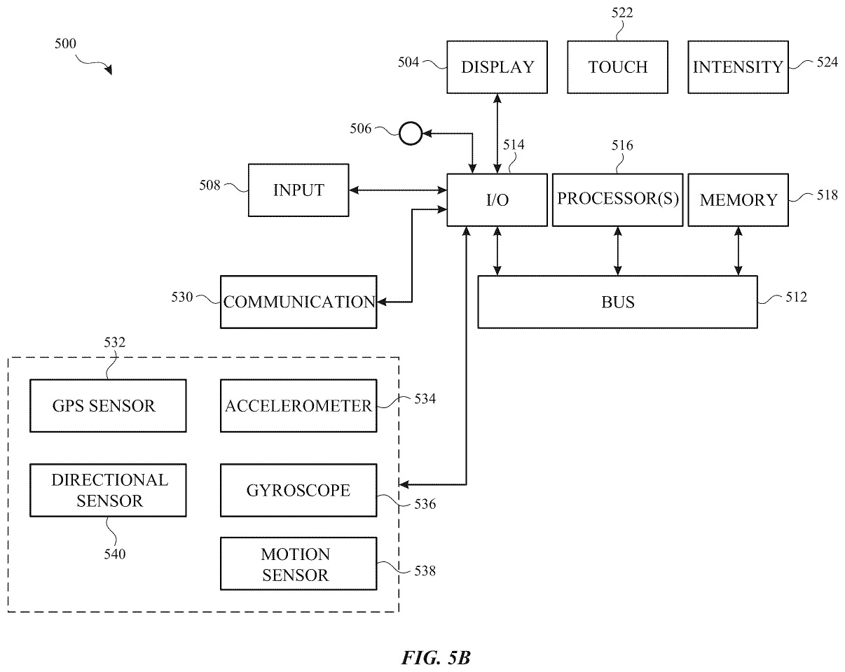

FIG. 5A illustrates a personal electronic device in accordance with some embodiments.

FIG. 5B is a block diagram illustrating a personal electronic device in accordance with some embodiments.

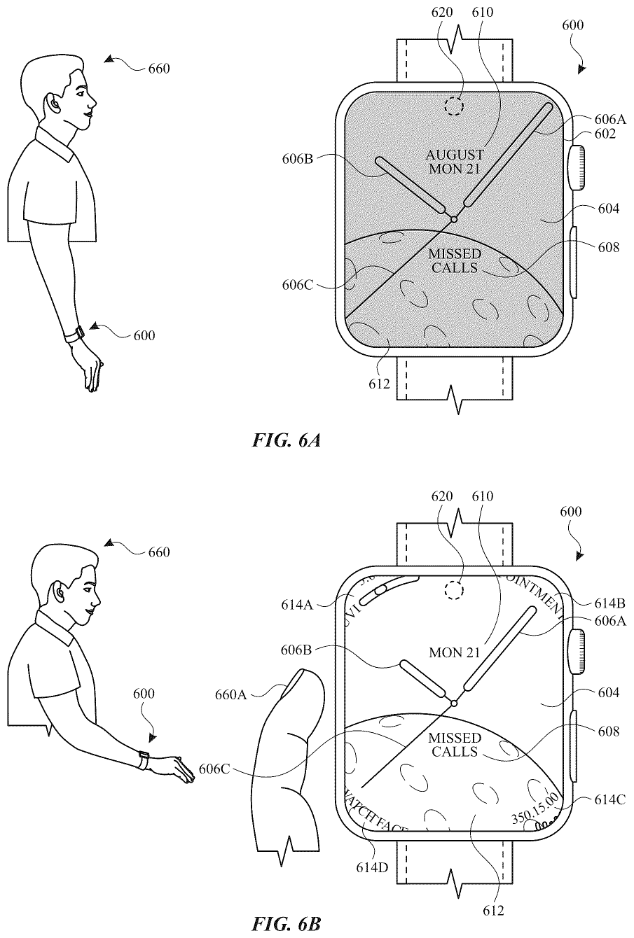

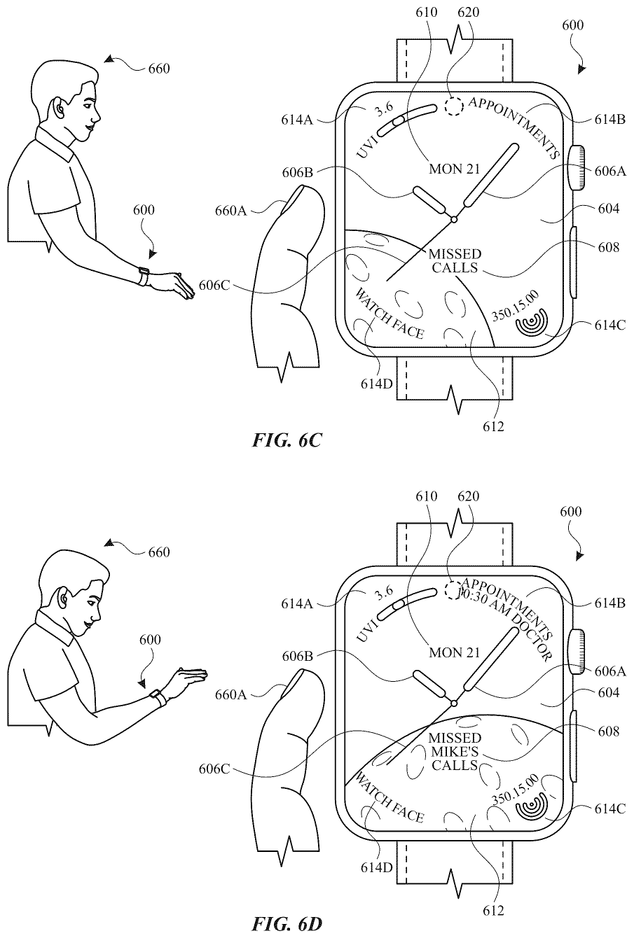

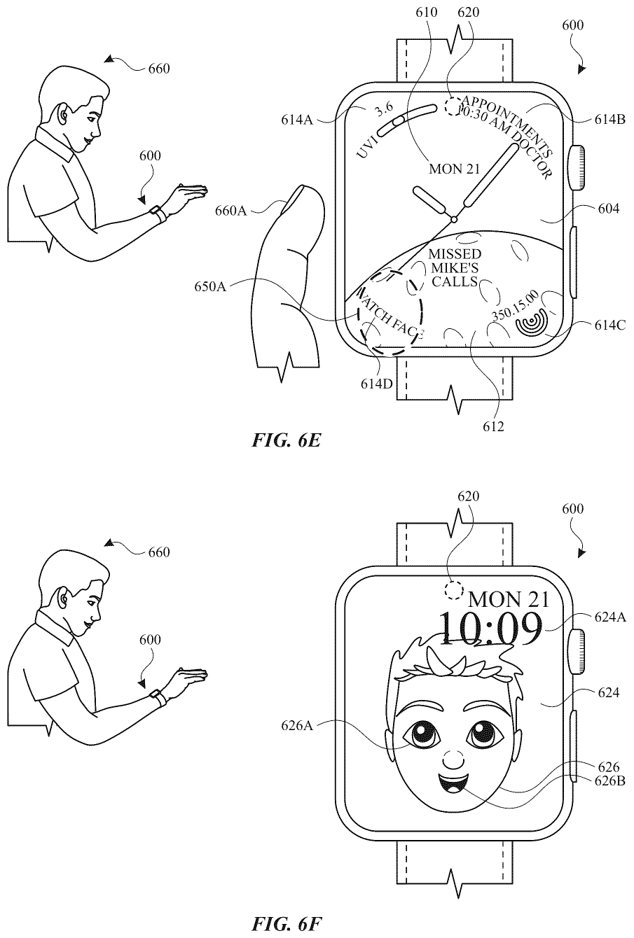

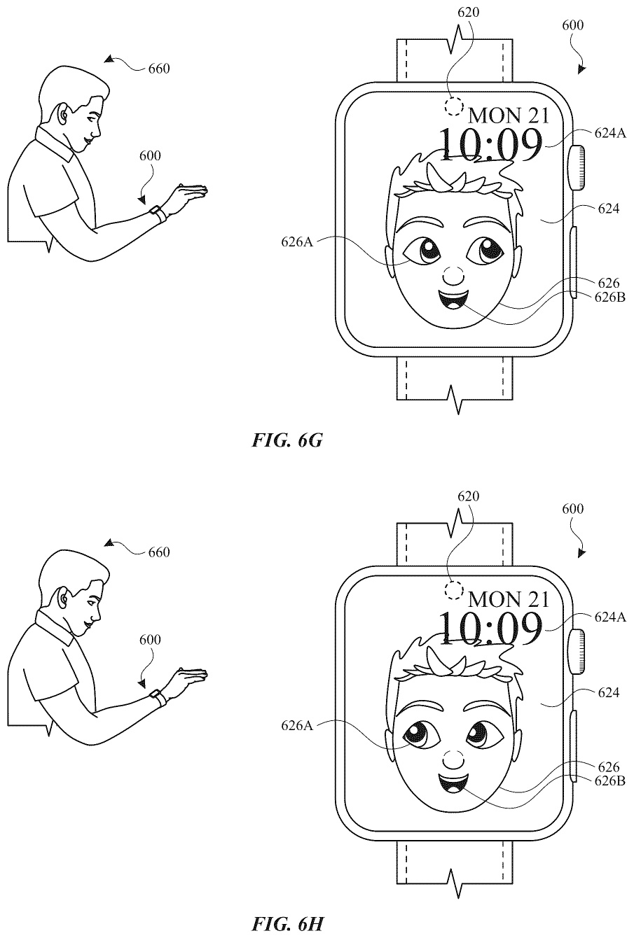

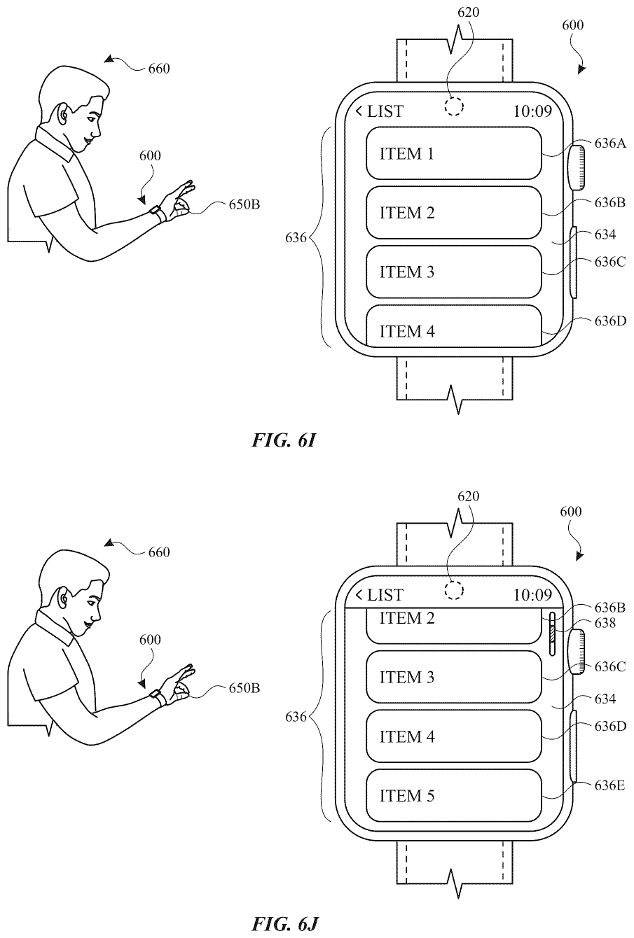

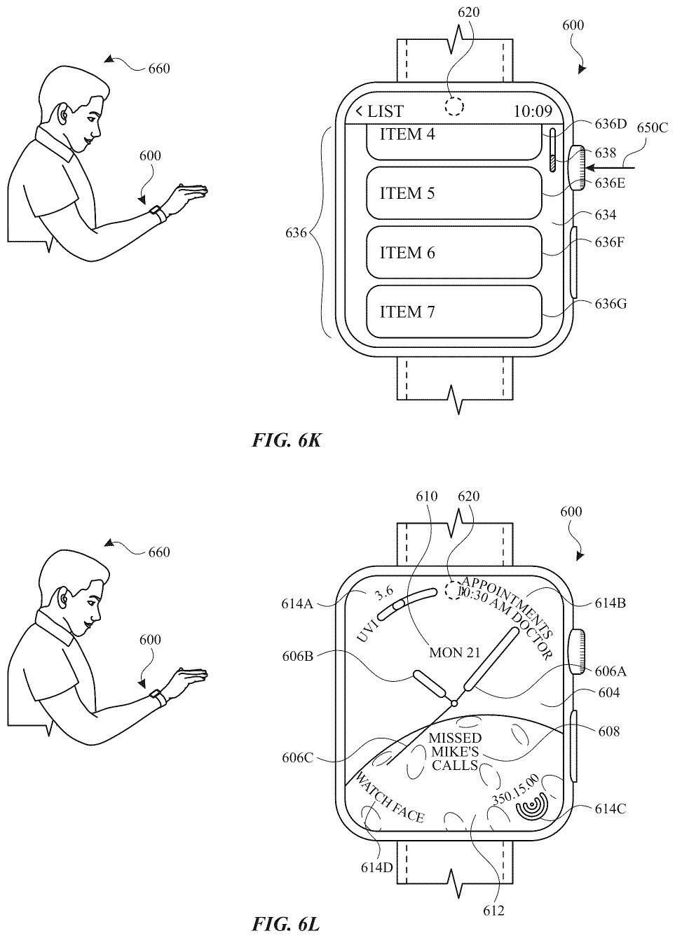

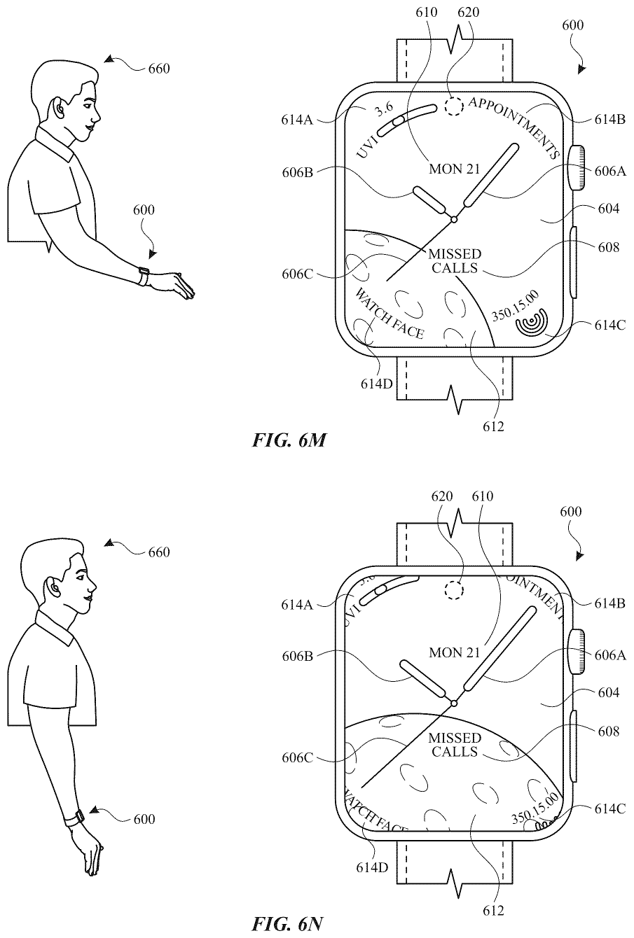

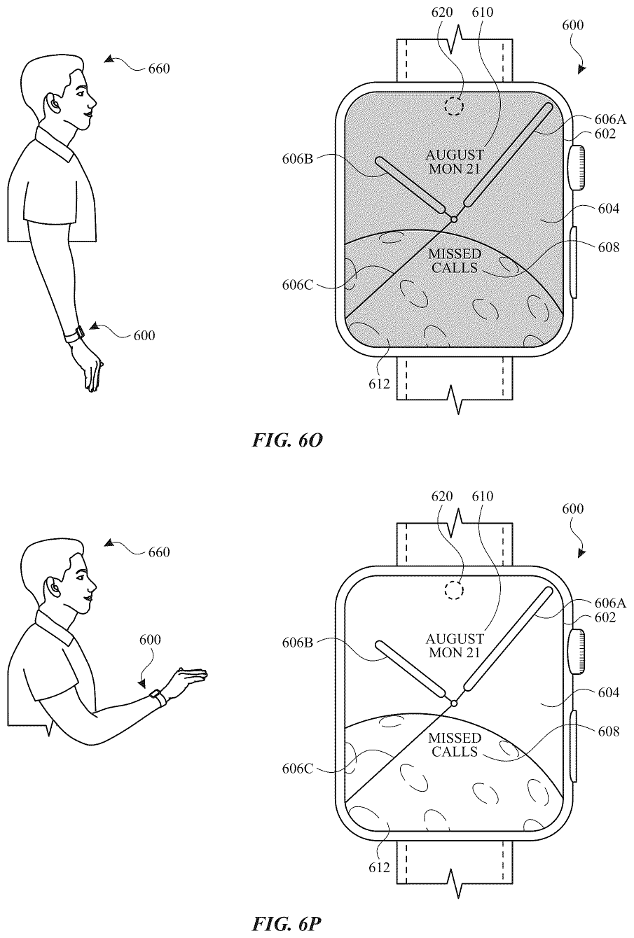

FIGS. 6A-6P illustrate exemplary user interfaces for updating user interfaces based on presence detection.

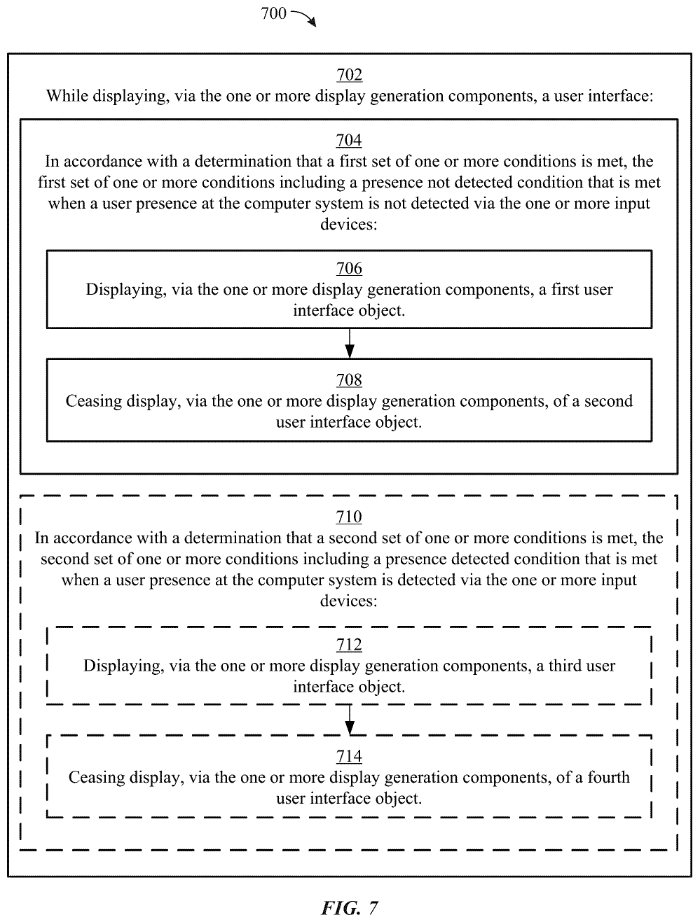

FIG. 7 is a flow diagram illustrating methods of updating user interfaces based on presence detection, in accordance with some embodiments.

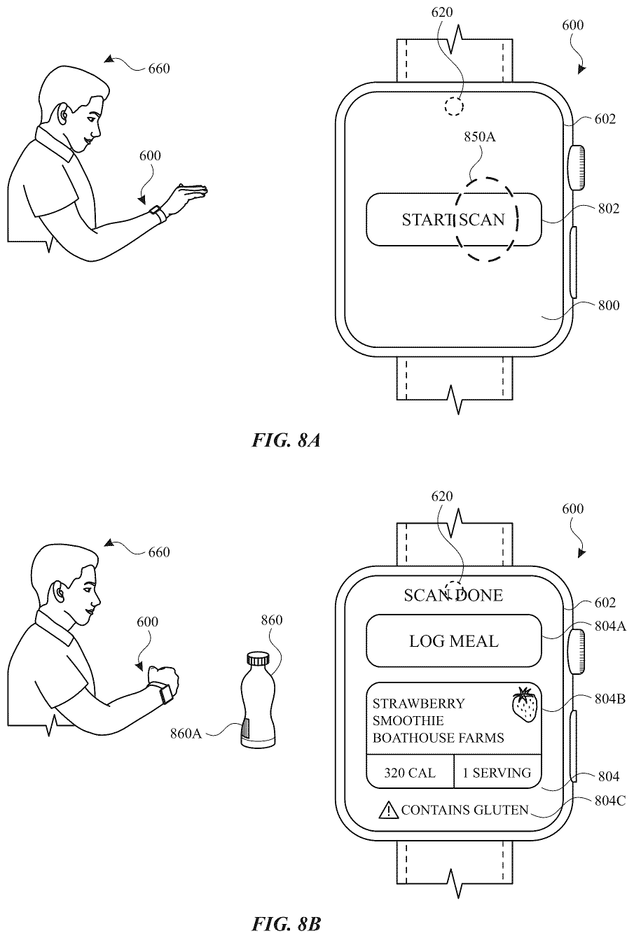

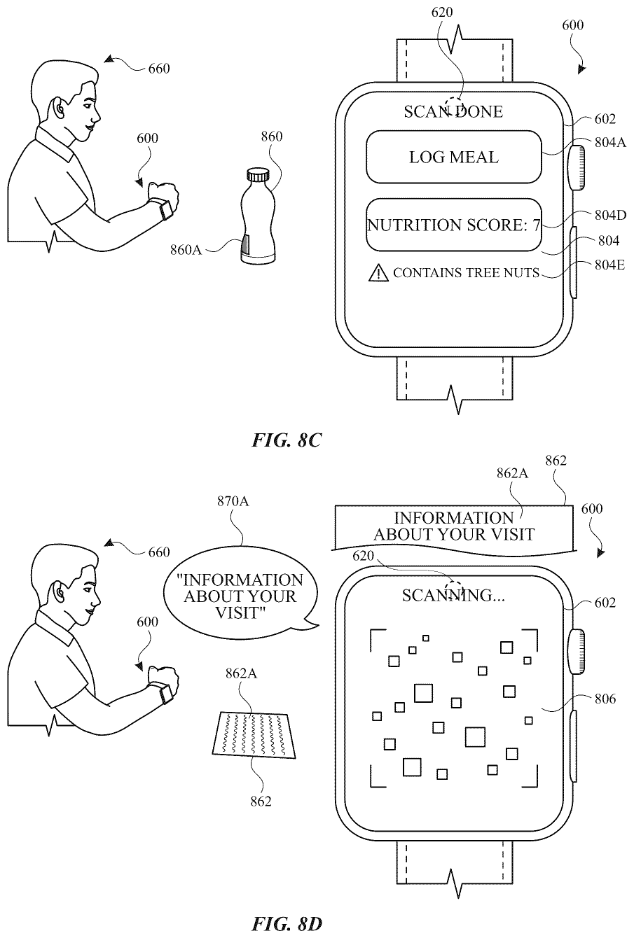

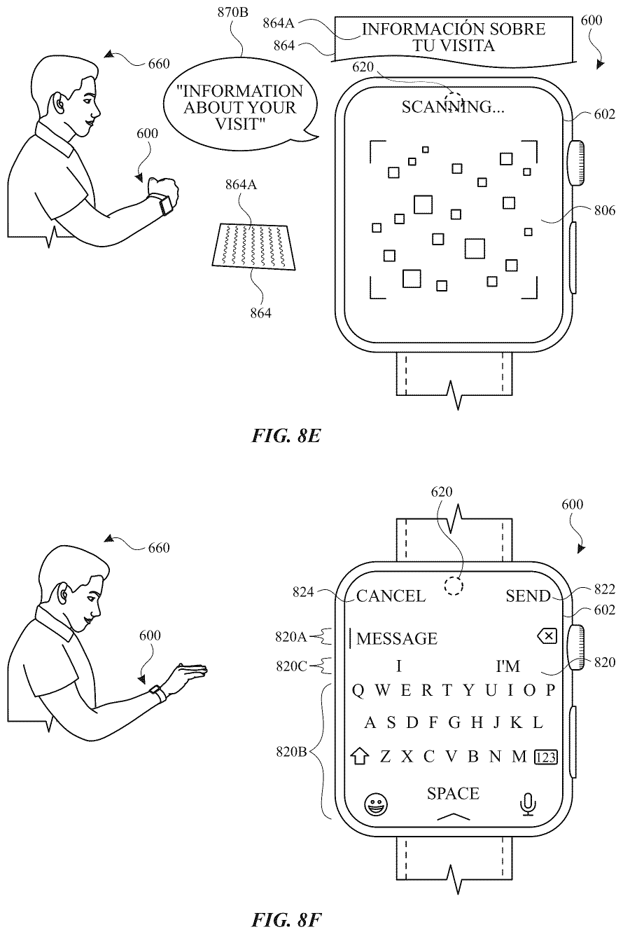

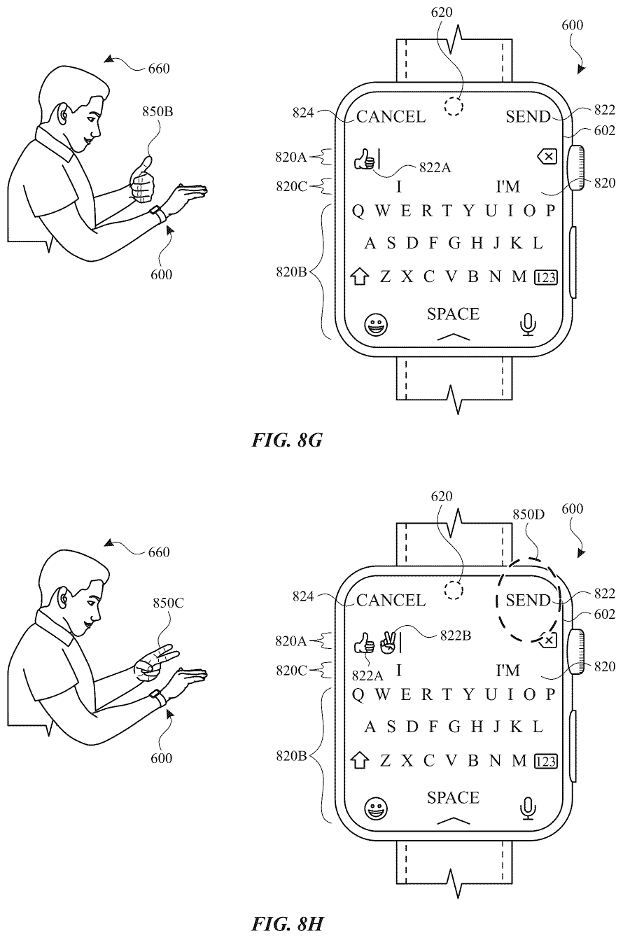

FIGS. 8A-8I illustrate exemplary user interfaces for outputting information about a real-world object.

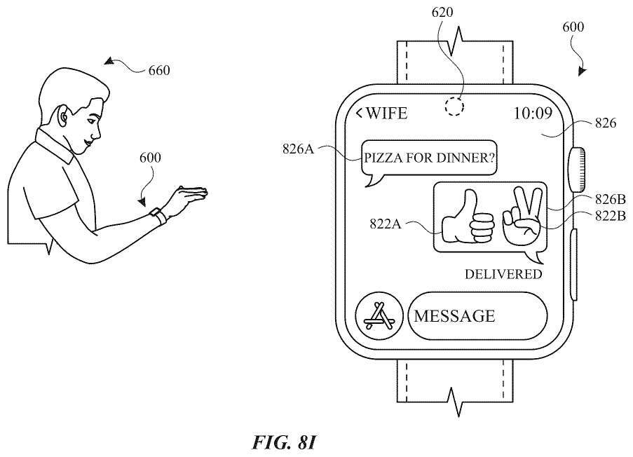

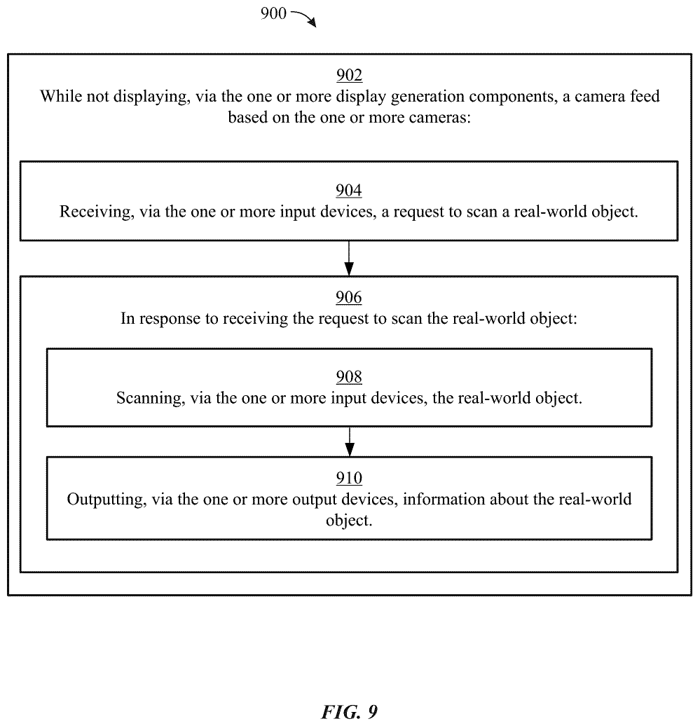

FIG. 9 is a flow diagram illustrating methods of outputting information about a real-world object.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for using object detection. For example, the electronic device updates a user interface based on presence detection of a user. For another example, the electronic device outputs information about a detected object. Such techniques can reduce the cognitive burden on a user who accesses electronic devices, thereby enhancing productivity. Further, such techniques can reduce processor and battery power otherwise wasted on redundant user inputs.

Below, FIGS. 1A-1B, 2, 3A-3G, 4A-4B, and 5A-5B provide a description of exemplary devices for performing the techniques for managing event notifications. FIGS. 6A-6P illustrate exemplary user interfaces for updating user interfaces based on presence detection. FIG. 7 is a flow diagram illustrating methods of updating user interfaces based on presence detection, in accordance with some embodiments. The user interfaces in FIGS. 6A-6P are used to illustrate the processes described below, including the processes in FIG. 7. FIGS. 8A-8I illustrate exemplary user interfaces for outputting information about a real-world object. FIG. 9 is a flow diagram illustrating methods of outputting information about a real-world object. The user interfaces in FIGS. 8A-8I are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system.

In some embodiments, a gesture (e.g., a motion gesture) includes an air gesture. In some embodiments, input gestures (e.g., motion gestures) used in the various examples and embodiments described herein include air gestures performed by movement of the user's finger(s) relative to other finger(s) (or part(s) of the user's hand) for interacting with a computer system, in some embodiments. In some embodiments, an air gesture is a gesture that is detected without the user touching an input element that is part of the device (or independently of an input element that is a part of the device) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the motion of the portion(s) of the user's body is not directly detected and is inferred from measurements/data from one or more sensors (e.g., one or more accelerometers, one or more gyroscopes, an inertial measurement unit (IMU), one or more visual sensors, one or more muscle sensors, one or more electromyography sensors, and/or one or more electrical impulse sensors).

In some embodiments, input gestures (e.g., air gestures) used in the various examples and embodiments described herein include pinch inputs and tap inputs, for interacting with a computer system, in some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture (optionally referred to as a pinch air gesture or air pinch gesture) includes movement of two or more fingers of a hand to make contact with one another, that is, optionally, followed by an immediate (e.g., within 0-1 seconds) break in contact from each other. In some embodiments, the contact of the portions of the user's body (e.g., two or more fingers) is not directly detected and is inferred from measurements/data from one or more sensors (one or more accelerometers, one or more gyroscopes, an inertial measurement unit (IMU), one or more visual sensors, one or more muscle sensors, one or more electromyography sensors, and/or one or more electrical impulse sensors). A long pinch gesture that is an air gesture (optionally referred to as a pinch-and-hold air gesture, a long pinch air gesture, or a long air pinch gesture) includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture (optionally referred to as a double-pinch air gesture or an air double-pinch gesture) comprises two (e.g., or more) pinch inputs (e.g., performed by the same hand) detected in immediate (e.g., within a predefined time period, such as 1 second or 2 seconds) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patents application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” /multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700 and/or 900 (FIGS. 7 and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 900 (FIGS. 7 and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6P illustrate exemplary user interfaces for updating user interfaces based on presence detection, in accordance with some embodiments. The user interfaces in these figures are used to illustrate the processes described below, including the processes in FIG. 7.

FIG. 6A illustrates user 660 wearing computer system 600 on the wrist of their right hand. In these examples, computer system 600 is a smart watch. In other examples, computer system 600 is a wearable device of a type other than a smart watch. Computer system 600 includes visual sensor 620 (e.g., a color camera or monochrome camera) that is optionally positioned behind display 602, such that display 602 displays content at the location of visual sensor 620 (as shown in FIG. 6D) and such that visual sensor 620 is not readily visible to user 660.

While the hand of user 660 on which the watch is worn is by the side of user 660 (e.g., not raised to their chest or face), computer system 600 determines that computer system 600 is not being actively used and, in response, operates in a first mode. In some embodiments, the first mode includes operating display 602 in a low-power operation mode, such as with display 602 dimmed, as shown in FIG. 6A. In some embodiments, computer system 600 determines whether computer system 600 is being actively used or not based on a set of one or more presence conditions being met. For example, the set of one or more presence conditions optionally include one or more (e.g., all or less than all) of: user presence being detected, a hand being detected, and/or wrist (and therefore device) being raised and/or being in a raised position. In some embodiments, when computer system 600 fails to detect presence of a user (as described in further detail below), computer system 600 determines that computer system 600 is not being actively used and therefore operates in the first mode. In some embodiments, when computer system 600 detects that the hand of user 660 is not raised, computer system 600 determines that computer system 600 is not being actively used and therefore operates in the first mode. In some embodiments, when computer system fails to detect that a hand is present (e.g., within a threshold distance of compute system 600) (e.g., does not detect a finger of the user's left hand near the computer system; other than the hand on which computer system 600 is being worn), computer system 600 determines that computer system 600 is not being actively used and therefore operates in the first mode.

At FIG. 6A, computer system 600 is in the first mode based on the set of one or more presence conditions not being met, such as user 660 not being detected (e.g., user 660 is not within a field of view of visual sensor 620 and/or is not within a distance and/or a particular field of view of visual sensor 620) and/or computer system 600 not being raised via a wrist raise. While (e.g., based on) computer system 600 is in the first mode, computer system 600 displays, via display 602, watch face user interface 604. Watch face user interface 604 includes watch hands 606 (e.g., minute hand 606A, hour hand 606B, and second hand 606C), indication 610 of the current date (“August Mon 21”), and missed call indication 608 “Missed Calls”. In this example, background 612 shows an object (e.g., a moon) that optionally moves/shifts based on a change in detected position of the user with respect to computer system 600 to exhibit a simulated parallax effect.

At FIG. 6B, user 660 has raised their hand. Computer system 600 detects that computer system 600 has been raised (with the user's wrist) and (optionally, in response) determines whether the set of one or more presence conditions is met. At FIG. 6B, computer system determines that presence of user 660 is detected (e.g., user 660 is within a field of view of visual sensor 620 and/or is within a threshold distance and/or a particular field of view of visual sensor 620) and (optionally) that a hand of user 660 (e.g., finger of left hand, as shown in FIG. 6B) is near (within a threshold distance) of computer system 600. Thus, in response to the set of one or more presence conditions being met, computer system 600 transitions, as shown in FIG. 6B, out of the first mode and into second mode, as shown in FIG. 6C.

As part of transitioning out of the first mode and into the second mode, computer system 600 transitions display 602 out of the low-power operation mode (e.g., by brightening display 602), slides complications 614A-614D into view, reduces the size of hands 606A-606C, displays missed calls indication 608, and ceases to display the month (“August”) as part of indication 610 of the current date. Thus, while the set of one or more presence conditions are not met, computer system 600 optionally stays in a low-power mode, thereby conserving power, and reduces the amount of private information displayed (and potentially viewable by others), thereby increasing information security.

At FIG. 6C, computer system 600 has completed the transition from the first mode to the second mode. Complications 614A-614D are displayed in the corners of watch user interface 604. Complication 614A indicates the current UV index, complication 614B relates to appointments, complication 614C indicates exercise metrics, and complication 614D relates to other watch faces. As shown in FIG. 6C, complication 614B is displayed at a location previously occupied by minute hand 606A (at FIG. 6A, while in the first mode). Further, the month “August” of indication 610 of the current date is no longer displayed, thereby reducing visual clutter on watch face user interface 604 and providing more space for display of relevant information. At FIG. 6C, although the set of one or more presence conditions is met, computer system 600 has determined that user 660 (e.g., the face of user 660) is not within a proximity threshold (e.g., threshold distance of 6 inches, 10 inches, or 18 inches) of computer system 600 (e.g., display 600 and/or visual sensor 620) to display particularly sensitive information and, accordingly, complication 614B does not include details about an upcoming appointment and missed calls indication does not include details about the missed call. At FIG. 6C, as computer system 600 detects a change in a position of the user relative to computer system 600, computer system 600 moves/shifts the moon in background 612 based on the change to exhibit a simulated parallax effect.

At FIG. 6D, user 660 has further raised their hand. Computer system 600 detects that computer system 600 has been further raised (with the user's wrist) and (optionally, in response) determines that computer system 600 is now within the proximity threshold (e.g., threshold distance of 6 inches, 10 inches, or 18 inches) of user 660 (e.g., is now closer to the user and/or to the user's face). While the set of one or more presence conditions is met and in response to computer system 600 coming within the proximity threshold of user 660, computer system 600 displays additional (e.g., private and/or sensitive) information (and optionally removes other information) on display 602. For example, as shown in FIG. 6D, computer system 600 updates display of complication 614B to include that a “doctor” appointment is scheduled for “10: 30 am.” For another example, missed calls indication 608 is updated to include the name (“Mike”) of the person from whom the call was missed. Accordingly, certain information (e.g., particularly sensitive information) is not displayed until computer system 600 is closed to user 660. In some embodiments, different levels of additional information as displayed at various proximity thresholds. For example, as computer system 600 continues being raised to be closer to user 600, even more information is displayed (e.g., most sensitive information, such as bank account balance information and/or health information). At FIG. 6D, as computer system 600 detects a change in a position of the user relative to computer system 600, computer system 600 moves/shifts the moon in background 612 based on the change to exhibit a simulated parallax effect.

At FIG. 6E, while the set of one or more presence conditions is met, computer system 600 detects input (e.g., a tap input and/or a tap-and-hold) directed to complication 614D and, in response displays animated avatar watch face 624, as shown in FIG. 6F.

At FIG. 6F, animated avatar watch face 624 includes current time 624A and avatar 626. Avatar 626 is animated and includes eyes 626A and mount 626B. As shown in FIGS. 6F-6H, computer system 600 updates avatar 626 based on detected movement of user 660. In some embodiments, computer system 600 moves eyes 626A of avatar 626 in conjunction with movement of the eyes of user 660. In some embodiments, movement of eyes 626A mimic the movement of the eyes of user 660 (e.g., eyes 626A move in the same direction and/or to the same degree as the eyes of user 660). In some embodiments, computer system 600 updates facial expressions of avatar 626 in conjunction with facial expressions of user 660. In some embodiments, movement of mount 626B mimic the movement of the mount of user 660 (e.g., mouth 626B moves in the same manner and/or to the same degree as the mouth of user 660).

At FIG. 6F, user 660 is looking forward and eyes 626A are centered. At FIG. 6G, computer system 600 detects that user 660 is looking to the left and updates eyes 626A to look to the left. At FIG. 6H, computer system 600 detects that user 660 is looking to the right and updates eyes 626A to look to the right.

As shown in FIG. 6I, computer system 600 has detected a user request to display a list of items and, in response, displays list user interface 634 that includes list 636. At FIG. 6I, computer system 600 detects a request to scroll list 636. In some embodiments, the request to scroll list 636 includes computer system 600 detecting air pinch gesture 650B (using the hand on which computer system 600 is worn). In some embodiments, the request to scroll list 636 includes computer system 600 detecting that a gaze of user 660 is directed to computer system 600 (e.g., to display 660 and/or to list 636). In some embodiments, the request to scroll list 636 is received when computer system 600 concurrently detects that the gaze of user 660 is directed to computer system 600 and that the user is performing air pinch gesture 650B. In response to detecting the request to scroll list 636, computer system 600 scrolls list 636, as shown in FIGS. 6J-6K. As shown in FIG. 6K, computer system 600 stops detecting the request to scroll list 636 (and optionally stops scrolling and/or slows scrolling of list 636) based on user 660 no longer performing air pinch gesture 650B, as shown in FIG. 6K. In some embodiments, in response to receiving the request to scroll list 636, computer system 600 displays scroll indicator 638, which indicates that list 636 is being scrolled and/or the scroll position of list 636. In some embodiments, a direction of scroll for scrolling list 636 is based on a direction of the gaze of user 660. In some embodiments, in accordance with the gaze of user 660 being directed to the top of display 602 while computer system 600 detects air pinch gesture 650B, computer system 600 scrolls list 636 in a first direction (e.g., down) and in accordance with the gaze of user 660 being directed to the bottom of display 602 while computer system 600 detects air pinch gesture 650B, computer system 600 scrolls list 636 in a second direction (e.g., up) that is different from the first direction. At FIG. 6K, computer system 600 detects button press 650C and, in response, returns to displaying watch face user interface 604, as shown in FIG. 6L.

At FIG. 6L, based on the set of one or more presence conditions being met, computer system 600 is in the second mode and is displaying watch face user interface 604. Because computer system 600 is within the proximity threshold of user 660 (e.g., of the face of user 660), computer system 600 displays additional (e.g., private and/or sensitive) information on display 602, such as complication 614B including that a “doctor” appointment is scheduled for “10:30 am” and such as missed calls indication 608 including the name (“Mike”) of the person from whom the call was missed.

At FIG. 6M, based on the set of one or more presence conditions continuing to be met, computer system 600 remains in the second mode. Because computer system 600 is no longer within the proximity threshold of user 660 (e.g., of the face of user 660), computer system 600 ceases to display the additional (e.g., private and/or sensitive) information on display 602 (e.g., ceases to display “Mike” and “doctor”).

At FIG. 6N, as user 660 lowers their arm and visual sensor 620 no longer detects user 660 (e.g., the face of user 660), computer system 600 determines that the set of one or more presence conditions is no longer met and, in response, animates changes to watch face user interface 604, as shown in FIGS. 6N-60. In some embodiments, the animation is a reverse of the animation resulting from computer system 600 detecting that the set of one or more presence conditions is being met, as in FIGS. 6B-6C. For example, at FIG. 6N, complication 614B ceases to include the appointment information (e.g., “doctor”), complications 614A-614D begin to slide out of view, missed calls indication 608 ceases to include the name of the person (e.g., “Mike”), and indication 610 of the current date again begins to display the month (e.g., “August”).

At FIG. 6O, minute indicator 606A has enlarged to be displayed at the location previously occupied by complication 614B. At FIG. 6O, in accordance with a determination that the set of one or more presence conditions is no longer met and/or with a determination that the wrist of user 660 is down, computer system 600 transitions back into the first mode, including dimming display 602.

At FIG. 6P, computer system 600 detects that user 660 has raised their hand (and, therefore, computer system 600) and, in response, computer system 600 transitions from the first mode (e.g., operating display 602 in a low-power operation mode) to the second mode (operating display 602 in a standard operation mode), thereby brightening display 602. However, computer system 600 determines (e.g., in response to detecting the hand raise gesture) that the set of one or more presence conditions is not met (e.g., because user 660 is not within a field of view of visual sensor 620, because finger 660A is not within a threshold distance of computer system 600, and/or because the user's gaze is not directed at computer system 600) and, in response, computer system 600 forgoes to update watch face user interface 604 to display complications 614, to reduce the size of time indicators 606A-606C, and to cease displaying the month (e.g., “August”) as part of indication 610 of the current date. Accordingly, although computer system 600 detects that the hand and the computer system 600 have been raised, limited information is displayed on display 602 when computer system 600 determines that the set of one or more presence condition is not met (e.g., computer system 600 is not being actively used), thereby conserving power and keeping the information more secure. In some embodiments, computer system 600 remains in the first mode (e.g., operating display 602 in a low-power operation mode) to conserve additional power.

FIG. 7 is a flow diagram illustrating a method for updating user interfaces based on presence detection using a computer system, in accordance with some embodiments. Method 700 is performed at a computer system (e.g., 100, 300, 500, and/or 600) (e.g., a smartphone, a desktop computer, a laptop, a tablet, a wearable device (e.g., a smart watch or a wearable fitness tracker), a head-mounted device, and/or a projection-based system) that is in communication with one or more input devices (e.g., a camera (e.g., 620) (e.g., an infrared camera, a depth camera, a visible light camera, and/or a gaze tracking camera), a gyroscope, an accelerometer, a mouse, a trackpad, and/or a physiological sensor (e.g., a blood pressure sensor and/or a heart rate sensor)) and one or more display generation components (e.g., 602) (e.g., a head-mounted display system, a display (e.g., a touch-sensitive display), a projector, a 3D display, a display having at least a portion that is transparent or translucent on which images can be projected (such as, e.g., a see-through display), a heads-up display, and/or a display controller). In some embodiments, the one or more input devices are integrated into the computer system. In some embodiments, the one or more input devices are integrated into an external device (e.g., a wearable device) that is in communication with the computer system. Some operations in method 700 are, optionally, combined, the orders of some operations are, optionally, changed, and some operations are, optionally, omitted.

As described below, method 700 provides an intuitive way for updating user interfaces based on presence detection. The method reduces the cognitive burden on a user for using presence detection, thereby creating a more efficient human-machine interface. For battery-operated computing devices, enabling a user to use presence detection faster and more efficiently conserves power and increases the time between battery charges.

While displaying (702), via the one or more display generation components (e.g., 602), a user interface (e.g., 604) and in accordance with (704) (and/or in response to) a determination that a first set of one or more conditions is met, the first set of one or more conditions including a presence not detected condition that is met when a user presence (e.g., based on or independent from identification of the user (e.g., 660)) at the computer system (e.g., 600) is not detected (e.g., is no longer detected (e.g., using visual detection and/or not using audio detection)) via the one or more input devices (e.g., 620) (e.g., transitioning from detecting presence of a user to not detecting presence (e.g., detecting no presence) of a user) (e.g., as in FIG. 6N), the computer system (e.g., 600) displays (706), via the one or more display generation components, a first user interface object (e.g., “August” in indication 610) and/or ceases display (708), via the one or more display generation components, of a second user interface object (e.g., 614A-614D). Updating display of content based on user presence enables the computer system to display more and/or less information without the need for additional user input, thereby reducing the number of inputs required and making the computer system more efficient. Additionally, ceasing to display information when the presence of a user is no longer detected enables the computer system to reduce the display duration of the information, thereby reducing the risk that the information is seen by an unauthorized person, thereby increasing the security of the information and the computer system.

In some embodiments, while displaying (702), via the one or more display generation components, the user interface (e.g., 604) and in accordance with (710) (and/or in response to) a determination that a second set of one or more conditions is met, the second set of one or more conditions including a presence detected condition that is met when a user presence (e.g., based on or independent from identification of the user) at the computer system is detected (e.g., visual detection and/or not audio detection) via the one or more input devices (e.g., 620) (e.g., transitioning from not detecting presence of a user to detecting presence of a user) (e.g., as in FIG. 6B), the computer system (e.g., 600) displays (712), via the one or more display generation components (e.g., 602), a third user interface object (e.g., 614A-614D) and/or ceases display (714), via the one or more display generation components (e.g., 602), of a fourth user interface object (e.g., “August” in indication 610). Updating display of content based on user presence enables the computer system to display more and/or less information without the need for additional user input, thereby reducing the number of inputs required and making the computer system more efficient. Additionally, ceasing to display information when the presence of a user is detected enables the computer system to reduce the display duration of the information, thereby reducing the risk that the information is seen by an unauthorized person, thereby increasing the security of the information and the computer system.

In some embodiments, the computer system (e.g., 600) is a wearable device (e.g., a smart watch, a wearable fitness tracker, a head-mounted device, and/or a projection-based system) and the computer system (e.g., 600) is being worn (e.g., on a part (e.g., a wrist, a head, and/or a foot) of a body of a user) (e.g., by user 660) when the presence not detected condition is met. In some embodiments, the first set of one or more conditions includes a worn condition that is met when the computer system is currently being worn by a user. In some embodiments, computer system is a wearable device (e.g., a smart watch, a wearable fitness tracker, a head-mounted device, and/or a projection-based system) and the computer system is being worn (e.g., on a part (e.g., a wrist, a head, and/or a foot) of a body of a user) when the presence detected condition is met. In some embodiments, the second set of one or more conditions includes a worn condition that is met when the computer system is currently being worn by a user. The computer system being a wearable device that is being work when the presence determination/analysis performed enables the computer system to be worn while transitioning between states of a user being present or not, thereby reducing the number of user inputs required to update the display of content.

In some embodiments, the first set of one or more conditions includes a proximity condition that is based on proximity of a user to the computer system (e.g., as in FIGS. 6D and 6M). In some embodiments, the proximity condition is not met when the proximity of the user is less than a threshold proximity and/or the user is detected withing a proximity range. In some embodiments, the proximity condition is met when a proximity of a user is more than a threshold proximity and/or a user is not detected within a proximity range. In some embodiments, the proximity condition is not met when a proximity of the user is less than the threshold proximity (e.g., is within a proximity range). In some embodiments, the second set of one or more conditions includes a second proximity condition that is based on proximity. In some embodiments, the second proximity condition is met when a proximity of a user is less than a second threshold proximity (e.g., same as the threshold proximity) and/or a user is detected within a proximity range. In some embodiments, the second proximity condition is not met when a proximity of the user is more than the threshold proximity (e.g., is not within a proximity range). In some embodiments, the proximity and presence conditions are analyzed separately. In some embodiments, proximity and presence are detected separately. In some embodiments, as the proximity of the user to the computer system (e.g., display of the computer system) changes, the computer system displays additional information and/or ceases to display some information. In some embodiments (e.g., while the computer system continues to detect presence of the user), as the user gets closer to the computer system, additional (e.g., sensitive) information is displayed (e.g., private calendar information and/or the user's health information) and as the user gets further from the computer system the additional (e.g., sensitive) information ceases to be displayed. Updating display of content based on user proximity enables the computer system to display more and/or less information without the need for additional user input, thereby reducing the number of inputs required and making the computer system more efficient. Additionally, ceasing to display information when the proximity of a user is not within a threshold range enables the computer system to reduce the display duration of the information, thereby reducing the risk that the information is seen by an unauthorized person, thereby increasing the security of the information and the computer system.

In some embodiments, the proximity condition is based on proximity (e.g., of a user and/or a portion of a user) to a display (e.g., 602) (e.g., a front display and/or a front of a display) of the computer system (e.g., 600). In some embodiments, the second proximity condition is based on proximity (e.g., of a user and/or a portion of a user) to the front display of the computer system. Updating display of content based on user proximity to a display of the computer system enables the computer system to display more and/or less information without the need for additional user input, thereby reducing the number of inputs required and making the computer system more efficient. Additionally, ceasing to display information when the proximity of a user is not within a threshold range to the display enables the computer system to reduce the display duration of the information, thereby reducing the risk that the information is seen by an unauthorized person, thereby increasing the security of the information and the computer system.

In some embodiments, the one or more input devices includes a visual sensor (e.g., 620) (e.g., a color camera and/or a monochrome camera) and wherein user presence (e.g., based on or independent from identification of the user) at the computer system (e.g., 600) is detected and/or not detected (e.g., is no longer detected (e.g., using visual detection and/or not using audio detection)) via the visual sensor (e.g., 620). In some embodiments, proximity (e.g., of a user and/or a portion of the user) is determined using the visual sensor. Using a visual sensor to detect presence and/or proximity enables the computer system to display more and/or less information without the need for additional user input, thereby reducing the number of inputs required and making the computer system more efficient.

In some embodiments, the visual sensor (e.g., 620) is an under-display visual sensor (e.g., an under-display camera, as indicated by dotted lines of 620). In some embodiments, an under-display visual sensor is positioned under a display such that the field of view of the visual sensor includes an area of the display that displays images. Using an under-display visual sensor enables the computer system to detect presence at the display and/or proximity from the display, which displays information that can benefit from being secured.

In some embodiments, user presence (e.g., based on or independent from identification of the user) at the computer system (e.g., 600) is not detected (e.g., is no longer detected (e.g., using visual detection and/or not using audio detection)) via the one or more input devices (e.g., 620) based on a failure to detect a face (e.g., the user's face, such as face of user 660) via the one or more input devices (e.g., 620) (e.g., detecting that a face is not within a field of view (or a particular portion of the field of view) of the visual sensor and/or detecting that a face is no longer in the field of view (or a particular portion of the field of view) of the visual sensor). In some embodiments, user presence (e.g., based on or independent from identification of the user) at the computer system is detected via the one or more input devices based on detecting that a face (e.g., the user's face) is detected via the one or more input devices. Determining user presence based on whether a user's face is detected enables the computer system to identify whether the user's attention is directed to the computer system, thereby limiting access to information when the user's attention is not directed to the computer system and making the computer system more secure.

In some embodiments, the computer system (e.g., 600) detects movement (e.g., detecting a particular type of movement, such as a movement indicative of a wrist raise up or a wrist being put down by a user wearing the computer system) of the computer system (e.g., 600). In response to detecting the movement (e.g., as in FIG. 6B) of the computer system (e.g., 600), the computer system (e.g., 600) activates (e.g., turning on, powering up, and/or increasing power to) a visual sensor (e.g., 620) (e.g., a color camera and/or a monochrome camera) of the one or more input devices to capture visual data (e.g., images and/or videos) using the visual sensor (e.g., 620), wherein the visual data is used (e.g., by the computer system) to determine user presence (e.g., determine that the user is present at the computer system or is not present at the computer system). In some embodiments, the computer system determines whether one or more (e.g., some or all) conditions of the first set of one or more conditions is met in response to detecting the movement of the computer system. In some embodiments, the computer system detects a movement (e.g., detecting a particular type of movement, such as a movement indicative of a wrist raise up or a wrist being put down by a user wearing the computer system) of the computer system and, in response, the computer system determines whether one or more (e.g., some or all) conditions of the first second of one or more conditions and/or second set of one or more conditions is met. Activating, based on movement of the computer system, a visual sensor to capture visual data for use in determining user presence enables the computer system to keep the visual sensor deactivated at some times, thereby making the computer system more efficient and reducing the amount of power consumed by the computer system.

In some embodiments, the computer system (e.g., 600) detects user input (e.g., movement (e.g., detecting a particular type of movement, such as a movement indicative of a wrist raise up or a wrist being put down by a user wearing the computer system) of the computer system; and/or touch input at a touchscreen of the computer system) and in response to detecting the user input (e.g., the movement (e.g., corresponding to a wrist raise or wrist being put down) of the computer system), the computer system (e.g., 600) transitions the computer system (e.g., 600) from a first power mode (e.g., a low-power mode, as in FIG. 6A) to a second power mode (e.g., to a standard power mode and/or a high power mode, as in FIG. 6B) that is different from the first power mode. In some embodiments, a display of the computer system is dimmed during the first power mode and the display is not dimmed during the second power mode. In some embodiments, user presence is not determined while in the first power mode. In some embodiments, while in the second power mode, the computer system determines whether a user is present. Transitioning from a first power mode (e.g., a low power mode) to a second power mode (e.g., a higher power mode) enables the computer system to reside in the low power mode for some durations, thereby reducing the power consumption of the computer system.

In some embodiments, the first user interface object (e.g., “August” in indication 610) is a complication (e.g., for reporting stock prices, for displaying weather information, and/or displaying timer/stopwatch information) of a watch face (e.g., a complication displayed adjacent to an edge and/or in a corner of the watch face and/or display of the computer system) and the second user interface object (e.g., 614A-614D) is a complication (e.g., for reporting stock prices, for displaying weather information, and/or displaying timer/stopwatch information) of the watch face (e.g., a complication displayed adjacent to an edge and/or in a corner of the watch face and/or display of the computer system). In some embodiments, the third user interface object and the fourth user interface object are complications (e.g., for reporting stock prices, for displaying weather information, and/or displaying timer/stopwatch information) of the watch face (e.g., displayed adjacent to an edge and/or in a corner of the watch face and/or display of the computer system). In some embodiments, a complication refers to any clock face feature other than those used to indicate the hours, minutes, and/or seconds of a time (e.g., clock hands or hour, minute, and/or second indications). In some embodiments, complications provide different types of information to a user, such as data obtained from an application. In some embodiments, the information conveyed to a user by a complication is customizable. In some embodiments, a complication is a user interface element that displays information from a corresponding application and can be selected to open the corresponding application (e.g., display a user interface of the application and/or replace display of the time and/or the clock face with the user interface of the corresponding application). Updating display of content based on user presence enables the computer system to display more and/or less information without the need for additional user input, thereby reducing the number of inputs required and making the computer system more efficient. Additionally, ceasing to display information when the presence of a user is no longer detected enables the computer system to reduce the display duration of the information, thereby reducing the risk that the information is seen by an unauthorized person, thereby increasing the security of the information and the computer system.

In some embodiments, in accordance with (and/or in response to) the determination that the first set of one or more conditions is met, the computer system (e.g., 600) changes (e.g., increasing or decreasing) a displayed size (and/or location) of a current time (e.g., hands 606A-606C). In some embodiments, in accordance with (and/or in response to) the determination that the second set of one or more conditions is met, the computer system changes (e.g., increasing, decreasing, and/or opposite of when the first set of conditions is met) a displayed size (and/or location) of a current time. Changing a display size of a displayed current time based on user presence enables the computer system to update the display without the need for additional user input, thereby reducing the number of inputs required and making the computer system more efficient. Reducing the displayed size of the current time also makes more space available for displaying other content, reducing the need for the user to provide inputs and traverse menus to view that content.

In some embodiments, in accordance with (and/or in response to) the determination that the first set of one or more conditions is met, the computer system (e.g., 600) changes (e.g., increasing or decreasing) a configuration of a displayed current time (e.g., 606A-606C would change to an analog time display) (e.g., from an analog display (with an hour, minute, and/or second hand) to a digital display (e.g., with textual numerals (e.g., 0, 1, 2, 3, 4, 5, 6, 7, 8, and/or 9))). In some embodiments, in accordance with (and/or in response to) the determination that the second set of one or more conditions is met, the computer system changes the configuration of the displayed current time (e.g., from digital display to analog display of time). Changing a configuration of a displayed current time based on user presence enables the computer system to update the display without the need for additional user input, thereby reducing the number of inputs required and making the computer system more efficient. Changing the configuration of the current time also optionally enables the computer system to configure the display for displaying other content, reducing the need for the user to provide inputs and traverse menus to view that content.

In some embodiments, the first user interface object is a complication (e.g., of a watch face, such as 604) and the second user interface object is a display of a current time (e.g., 606). In some embodiments, displaying the first user interface object and ceasing display of the second user interface object includes replacing display of the complication with a display of the current time (e.g., 606). In some embodiments, the third user interface object is the complication and the fourth user interface object is display of the current time, wherein when the second set of one or more conditions is met, display of the current time is replaced with the complication (e.g., of a watch face). Replacing complications (which can include personal or sensitive information) with display of time makes the information of the complications more secure, thereby making the computer system more secure.

In some embodiments, ceasing display of the second user interface object (e.g., “Mike” in missed call indication 608) includes ceasing display of first information (e.g., “Mike”) of a complication while maintaining display of second information (e.g., “Missed call”) of the complication. In some embodiments, displaying the third user interface object includes displaying first information of the complication (e.g., while maintaining display of the second information of the complication). In some embodiments, when the second set of one or more conditions is met (e.g., user presence is detected), the computer system displays additional information in one or more (e.g., 1, 2, or 3) complications of a watch face. In some embodiments, when the first set of one or more conditions is met (e.g., user presence is no longer detected), the computer system ceases displaying the additional information. Displaying less information in complications (which can include personal or sensitive information) makes the information no longer displayed more secure, thereby making the computer system more secure.

In some embodiments, the computer system (e.g., 600) displays, via the one or more display generation components (e.g., 602), an animation of an objection (e.g., moon 612 and/or avatar 626) (e.g., the second user interface object) based on user presence being detected. In some embodiments, the animated user interface object ceases to be displayed when the computer system no longer detects presence of the user. In some embodiments, the third user interface object includes an animation and/or is the same object as the second user interface object. Animating an object based on user presence being detected provides the user with visual feedback about the state of the computer system and that the computer system is detecting the presence of the user.

In some embodiments, in accordance with (and/or in response to) the determination that the first set of one or more conditions is met, the computer system (e.g., 600) modifies (e.g., changing, shrinking, and/or enlarging) a background (e.g., 612) (e.g., a background image and/or a background video) of the user interface (e.g., 604). In some embodiments, in accordance with (and/or in response to) the determination that the second set of one or more conditions is met, the computer system modifies (e.g., changes, shrinks, and/or enlarges) the background (e.g., a background image and/or a background video) of the user interface (e.g., by reversing the animation performed when the first set of one or more conditions was met). Modifying a background based on user presence being detected provides the user with visual feedback about the state of the computer system and that the computer system is detecting the presence of the user.

In some embodiments, the presence not detected condition is met when a face is not detected (e.g., as in FIG. 6P) (e.g., a particular face (e.g., an enrolled face) is not detected and/or no face is detected; using face detection and/or based on or independent from identification of the user) at the computer system (e.g., 600) via the one or more input devices (e.g., 620) (e.g., using a visual sensor). In some embodiments, the presence detected condition is met when a face is detected at the computer system via the one or more input devices (e.g., using a visual sensor). In some embodiments, user presence is based on face detection. In some embodiments, user presence is detected when a face is detected (e.g., within a threshold distance from the computer system). In some embodiments, user presence is not detected when a face is not detected (or when a face is not detected within the threshold distance from the computer system). In some embodiments, the computer system uses facial recognition to detect an enrolled face (e.g., a face of an enrolled user of the computer system) and user presence is detected when an enrolled face is detected (e.g., within a threshold distance from the computer system) and user presence is not detected when an enrolled face is not detected. In some embodiments, user presence is detected when any face (e.g., enrolled face or unenrolled face) is detected (e.g., within a threshold distance from the computer system) and user presence is not detected when a face (e.g., neither an enrolled face nor an unenrolled face) is not detected. Detecting user presence based on face detection enables the computer system to detect when a user's attention is most likely directed to the computer system, thereby improving the computer system's ability to detect the presence of the user.

In some embodiments, the computer system (e.g., 600) animates over time (e.g., gradually changing over time) a user interface object (e.g., 612 and/or 626) (e.g., the first user interface object, the second user interface object, the third user interface object, and/or the fourth user interface object) based on a proximity of a face (e.g., face of user 660) detected (e.g., using face detection) via the one or more input devices (e.g., 620). In some embodiments, the computer system gradually fades in a user interface object (e.g., the first, second, third, and/or fourth user interface object) as (e.g., in conjunction with) a face of the user is detected gradually getting closer to the computer system and fades out a user interface object (e.g., the first, second, third, and/or fourth user interface object) as (e.g., in conjunction with) a face of the user is detected gradually getting further from the computer system. Animating a change of a displayed object over time based on proximity to the user's faces provides the user with visual feedback that the user's face is within a threshold distance of the computer system and provides the user with feedback indicating that the presence and/or proximity of the user's face is the input that is causing the computer system to respond.

In some embodiments, the first set of one or more conditions includes a touch not detected condition that is met when a touch input (e.g., touch of finger 660A) (e.g., at a particular location and/or bottom of the computer system) is not detected via the one or more input devices (e.g., transitioning from detecting presence of a user to not detecting presence (e.g., detecting no presence) of a user). In some embodiments, the second set of one or more conditions includes a touch detected condition that is met when a touch input (e.g., at a particular location and/or bottom of the computer system) is detected via the one or more input devices (e.g., via a capacitive sensor). In some embodiments, the touch input is a touch using a first hand while the computer system is worn on a second (different) hand of the user. In some embodiments, user presence is based on hand detection. In some embodiments, user presence is detected when a hand is detected (e.g., touching the computer system and/or within a threshold distance from the computer system). In some embodiments, user presence is not detected when a hand is not detected (or when a hand is not detected within the threshold distance from the computer system). In some embodiments, the first set of one or more conditions including a hand not detected condition that is met when the computer system is not being worn (e.g., on a wrist of a user). In some embodiments, the second set of one or more conditions includes a hand detected condition that is met when the computer system is being worn (e.g., on the wrist of a user). Detecting user presence based on hand detection enables the computer system to detect when a user's attention is most likely directed to the computer system and/or when the user is wearing the computer system, thereby improving the computer system's ability to detect the presence of the user.

In some embodiments, a first change (e.g., including displaying the first user interface object and/or ceasing to display the second user interface object; and/or a first animation) applied to the user interface based on a first presence-based state (e.g., the first set of one or more conditions being met and/or a presence not detected condition being met) (e.g., transition among FIGS. 6M-6O) is reversed (e.g., transition among FIGS. 6A-6C) (e.g., the first change is reversed using a second animation) based on a second presence-based state (e.g., the second set of one or more conditions being met and/or a presence detected condition being met) that is different from the first presence-based state. In some embodiments, the second change is a first animation to display additional information in the user interface based on the computer system detecting presence of a user (e.g., the second set of one or more conditions being met) and the first change is a second animation (e.g., that is a reverse of the first animation) that ceases to display the additional information in the user interface based on the computer system not detecting presence of the user (e.g., the first set of one or more conditions being met). In some embodiments, the second change includes a first animation that includes animating into display (e.g., fading in and/or sliding into view) additional information based on the computer system detecting presence of a user (e.g., the second set of one or more conditions being met) and the first change is a second animation that includes animating off of the display (e.g., fading out and/or sliding out of view) the additional information based on the computer system not detecting presence of the user (e.g., the first set of one or more conditions being met). Reversing a previously applied change based on presence provides the user with visual feedback that the user-detected presence state of the computer system has changed, thereby providing improved visual feedback.

In some embodiments, the computer system (e.g., 600) detects (e.g., while displaying the user interface or while not displaying the user interface), via the one or more input devices (e.g., 620) (e.g., a camera (e.g., an infrared camera, a depth camera, a visual sensor, and/or a gaze tracking camera)), movement of a user (e.g., user 660) relative to the computer system (e.g., 600). In response to detecting the movement of the user relative to the computer system (e.g., 600), the computer system (e.g., 600) animates a change (e.g., change of 612 and. 626) via the one or more display generation components (e.g., 602), of the user interface (e.g., a portion of or an element of the user interface), wherein the change is based on the movement of the user (e.g., 660) relative to the computer system (e.g., 600) (e.g., a magnitude and/or direction of the change is based on a direction and/or magnitude of the movement of the user relative to the computer system). In some embodiments, a change (e.g., including displaying the first user interface object and/or ceasing to display the second user interface object; and/or a first animation) applied to the user interface is based on movement of a user relative to the computer system. In some embodiments, in accordance with the first set of one or more conditions being met, the computer system animates a change (e.g., to display the first user interface object and/or to cease displaying the second user interface object) that is based on movement of a user of the computer system relative to the computer system. In some embodiments, in accordance with the second set of one or more conditions being met, the computer system animates a change (e.g., to display the third user interface object and/or to cease displaying the fourth user interface object) that is based on movement of a user of the computer system relative to the computer system. Animating a change of the user interface based on the movement of the user provides the user with visual feedback that the user (and the user's movements) is being detected, thereby providing improved visual feedback.

In some embodiments, the movement of the user relative to the computer system includes movement of eyes of the user (e.g., 660) (e.g., a change in the direction of gaze) (e.g., a magnitude of the change is based on a magnitude of the movement of the user's eyes and/or a direction of the change is based on a direction of the movement of the user's eyes). In some embodiments, a displayed object (e.g., an animated character) is animated in conjunction with (and/or based on) the movement of the eyes of the user (e.g., a magnitude of the animation is based on a magnitude of the movement of the user and/or a direction of the animation is based on a direction of the movement of the user). In some embodiments, the computer system detects the movement of the eyes of the user and performs an operation (e.g., a simulated parallax effect and/or a scroll operation) based on the detected movement. Animating a change of the user interface based on the movement of the user's eyes provides the user with visual feedback that the user (and the user's eye movements) is being detected, thereby providing improved visual feedback.

In some embodiments, animating the change of the user interface (e.g., of moon 612) includes animating a simulated parallax effect. In some embodiments, the animation of the parallax effect provides a simulated effect of depth and/or 3D space. In some embodiments, the parallax effect causes different elements of the user interface to move at different speeds (e.g., in the same direction). In some embodiments, the computer system detects movement of the user's eyes with respect to the computer system and animates a shift in one or more elements in a direction and/or with magnitudes that are based on the movement of the user's eyes with respect to the compute system, thereby creating a 3D effect. In some embodiments, some elements of the user interface do not shit with the movement of the user's eyes with respect to the computer system. In some embodiments, as the computer system detects that the user's eyes have moved in a first direction with respect to the computer system, the computer system shifts the one or more elements in a second direction (e.g., different from the first direction and/or opposite from the first direction). Providing a simulated parallax effect based on movement of the user provides the user with visual feedback that the user (and the user's movements) is being detected, thereby providing improved visual feedback.

In some embodiments, animating the change of the user interface includes animating a character (e.g., 626) (e.g., a cartoonish character or an animal). In some embodiments, the animated character is configured to respond to movements of the user, such as by mimicking the user's movements. In some embodiments, animating the character includes the character portraying one or more facial expressions (e.g., winking, smiling, and/or frowning) in response to the computer system detecting the one or more facial expressions (e.g., winking, smiling, and/or frowning) being performed by the user. In some embodiments, animating the character includes the character moving (e.g., side-to-side, front-to-back, tilting, and/or rotating of a body part (e.g., a head and/or body)) in response to the computer system detecting the movement (e.g., side-to-side, front-to-back, tilting, and/or rotating of a body part (e.g., a head and/or body)) being performed by the user. Animating a character based on movement of the user provides the user with visual feedback that the user (and the user's movements) is being detected, thereby providing improved visual feedback. Additionally, this allows the user to pose a character intuitively based on the user's own pose, thereby reducing the number of inputs required to pose the character.

In some embodiments, the movement of the user (e.g., 660) relative to the computer system (e.g., 600) is based on a position of a face of the user (e.g., 660) and/or left-right movement of the face of the user (e.g., 600) (e.g., rotation of the user's head and/or translation of the user's head). In some embodiments, the computer system detects a position of a face of the user and/or detects a movement (e.g., left-right movement) of the face of the user and determines that the user is moving relative to the computer system. In some embodiments, the direction and/or magnitude of the animated change is based on a direction and/or magnitude of the movement of the face of the user. Animating a change of the user interface based on a face position and/or movement of the user provides the user with visual feedback that the user (and the user's position/movement) is being detected, thereby providing improved visual feedback.

In some embodiments, the computer system (e.g., 600) scrolls content (e.g., 636) based on a user presence being detected at the computer system (e.g., 600). In some embodiments, in accordance with (and/or in response to) a determination that a user presence at the computer system is detected (e.g., the second set of one or more conditions is met), the computer system scrolls contents. In some embodiments, the computer system receives user input (e.g., a swipe input and/or rotation of a rotatable input mechanism). In response to receiving the user input: in accordance with a determination that a user presence at the computer system is detected (e.g., the second set of one or more conditions is met), the computer system scrolls content and in accordance with a determination that a user presence at the computer system is not detected (e.g., the first set of one or more conditions is met), the computer system forgoes scrolling the content. Scrolling content based on user presence enables the computer system to scroll content when the user is present, thereby reducing the need for the user to provide scroll inputs. Further, not scrolling the content when the user is not present avoids the computer system scrolling content when the user is not present.

In some embodiments, the computer system (e.g., 600) scrolls content (e.g., 636) based on a gaze (e.g., a location of gaze, a direction of gaze, and/or a movement of gaze) of the user (e.g., 660) of the computer system (e.g., 600). In some embodiments, the computer system detects a gaze of the user. In response to detecting the gaze of the user: in accordance with a determination that the gaze is directed to the computer system (and/or a display of the computer system), the computer system scrolls content and in accordance with a determination that the gaze is not directed to the computer system, the computer system forgoes scrolling the content. In some embodiments, the content is scrolled based on both gaze and presence of the user. In some embodiments, the direction of scrolling of the content is based on a location and/or direction of the detected gaze (e.g., the content is scrolled so that new portions of the content are displayed near an edge (e.g., of a display or a display area) where the gaze is directed. In some embodiments, in accordance with (e.g., in response to) a determination that the gaze of the user is directed to a first location (e.g., on the display), the scroll is a scroll in a first direction and in accordance with (e.g., in response to) a determination that the gaze of the user is directed to a second location (e.g., on the display) that is different from the first location, the scroll is a scroll in a second direction that is different from the first direction (e.g., is opposite of the first direction). Scrolling content based on user gaze enables the computer system to scroll content when the user is gazing at the computer system, thereby reducing the need for the user to provide scroll inputs. Further, not scrolling the content when the user is not gazing at the computer system avoids the computer system scrolling content when the user's attention is not directed to the computer system.

In some embodiments, scrolling content based on the gaze of the user (e.g., 660) of the computer system (e.g., 600) includes: in accordance with a determination that the gaze is directed to the computer system (e.g., 600) (and/or a display of the computer system), the computer system (e.g., 600) scrolls content (e.g., 636); and in accordance with a determination that the gaze is not directed to the computer system (e.g., 600) (and/or a display of the computer system), the computer system (e.g., 600) forgoes (and/or ceases) scrolling the content (e.g., 636). Scrolling content based on user gaze enables the computer system to scroll content when the user is gazing at the computer system, thereby reducing the need for the user to provide scroll inputs. Further, not scrolling the content when the user is not gazing at the computer system avoids the computer system scrolling content when the user's attention is not directed to the computer system.

In some embodiments, scrolling content (e.g., 636) based on a gaze (e.g., a location of gaze, a direction of gaze, and/or a movement of gaze) of the user (e.g., 600) of the computer system (e.g., 600) includes: in accordance with a set of one or more scroll conditions being met (e.g., in response to detecting that the set of one or more scroll conditions are met), wherein the set of one or more scroll conditions include a gaze condition that is met when a gaze of the user (e.g., 660) is directed to the computer system (e.g., 660) and a confirmation condition that is met when a confirmation input (e.g., 650B) (e.g., a pinch air gesture) is received, the computer system (e.g., 600) scrolls the content (e.g., 636). In some embodiments, scrolling content based on a gaze (e.g., a location of gaze, a direction of gaze, and/or a movement of gaze) of the user of the computer system includes: in accordance with the set of one or more scroll conditions not being met, the computer system does not scroll the content and/or ceases scrolling the content. In some embodiments, while the user is gazing at the computer system and performing an air pinch gesture (e.g., using the hand on which the computer system is worn), the computer system scrolls content based on or in response to detecting the air pinch gesture. In response to the computer system detecting the user ceasing to gaze at the computer system and/or ceasing to perform the air pinch gesture, the computer ceases scrolling the content. Scrolling content based on user gaze and additional user input enables the computer system to scroll content when the user is gazing at the computer system and providing the additional user input, thereby reducing the likelihood of receiving inadvertent input that scrolls the content.

Note that details of the processes described above with respect to method 700 (e.g., FIG. 7) are also applicable in an analogous manner to the methods described below. For example, method 900 optionally includes one or more of the characteristics of the various methods described above with reference to method 700. For example, the same input device (e.g., visual sensor 620) is used for user presence detection as for object detection. For another example, the computer systems (e.g., 600) are the same computer systems. For brevity, these details are not repeated below.

FIGS. 8A-8I illustrate exemplary user interfaces for outputting information about a real-world object, in accordance with some embodiments. The user interfaces in these figures are used to illustrate the processes described below, including the processes in FIG. 9.

FIG. 8A illustrates computer system 600 being worn on a hand of user 660. Computer system 600 is displaying, via display 602, user interface 800 that includes option 802 for initiating a scan using visual sensor 620. At FIG. 8A, computer system 600 detects input 850A (e.g., a tap input and/or a tap-and-hold input) directed to option 802. In response to detecting input 850A, computer system 600 scans one or more real-world objects that are in the field of view of visual sensor 620. For example, user 660 turns their wrist such that display 602 and visual sensor 620 are facing the real-world object for scanning.

At FIG. 8B, in accordance with some embodiments, computer system 600 scans a computer-readable code (e.g., a bar code and/or a QR code) corresponding to an item and displays information about that item. At FIG. 8B, computer system 600 scans QR code 860A of smoothie drink product 860. In response to scanning QR code 860A, computer system 600 displays user interface 804, which includes option 804A to log nutrition information of the product into a log (e.g., tracking the calories and other nutritional information of foods and drinks the user has consumed), nutrition table 804B, and allergy information 804C. Nutrition table 804B includes a name of the product, ingredients of the product, calories of the product, and serving size information of the product. As shown in FIGS. 8A-8B, computer system 600 does not display a visual feed (e.g., a live feed) of the content being scanned by visual sensor 620.

At FIG. 8C, in accordance with some embodiments, in response to scanning QR code 860A, computer system 600 displays user interface 804, which includes option 804A to log nutrition information of the product into a log (e.g., tracking the calories and other nutritional information of foods and drinks the user has consumed), nutrition score 804D, and allergy information 804E. As shown in FIGS. 8A and 8C, computer system 600 does not display a visual feed (e.g., a live feed) of the content being scanned by visual sensor 620.

At FIG. 8D, in accordance with some embodiments, computer system 600 scans document 862 (e.g., that is sitting on a desk) that includes written (e.g., typed and/or handwritten) text 862A and outputs information about the document. In response to scanning document 862, computer system 600 outputs computer-generated spoken audio of the written text 862A of document 862 (e.g., without translating from one language to another). As shown in FIGS. 8A and 8D, computer system 600 does not display a visual feed (e.g., a live feed) of the content being scanned by visual sensor 620. User interface 806 indicates that a scan is being performed and is not a video feed of the content detected by visual sensor 620.

At FIG. 8E, in accordance with some embodiments, computer system 600 scans document 864 (e.g., that is sitting on a desk) that includes written (e.g., typed and/or handwritten) text 864A in a first language and outputs information about the document in a second language, different from the first language. In response to scanning document 864, computer system 600 outputs computer-generated spoken audio in the second language of the written text 864A in the first language of document 864 (e.g., by translating from the first language to the second language). As shown in FIGS. 8A and 8E, computer system 600 does not display a visual feed (e.g., a live feed) of the content being scanned by visual sensor 620. User interface 806 indicates that a scan is being performed and is not a video feed of the content detected by visual sensor 620.

At FIG. 8F, computer system 600 is displaying, via display 602, messaging user interface 820 (e.g., of an instant messaging application and/or of an email messaging application). Messaging user interface 820 includes input field 820A, keyboard 820B, suggestions 820C, send option 822 for sending the draft of the message to one or more recipients in a messaging conversation, and cancel option 824 for cancelling the drafting of the message. At FIG. 8F, computer system 600 has detected user input (e.g., the same input that caused display of keyboard 820B) and, in response, is scanning (via visual sensor 620) to capture a pose of a portion of the body of user 660. In some embodiments, computer system 600 captures the face of user 660 and selects an emoji (for insertion into input field 820A) based on an expression of user 660.

At FIG. 8G, computer system 600 detects, via visual sensor 620, thumbs up gesture 850B being performed by user 660 in the field of view of visual sensor 620. In response to detecting thumbs up gesture 850B, computer system 600 selects emoji 822A that corresponds to detected gesture 850B and inserts emoji 822A into input field 820A, as shown in FIG. 8G (e.g., without automatically sending the message).

At FIG. 8H, computer system 600 detects, via visual sensor 620, peace gesture 850C being performed by user 660 in the field of view of visual sensor 620. In response to detecting peace gesture 850C, computer system 600 selects emoji 822B that corresponds to detected gesture 850C and inserts emoji 822B into input field 820A next to emoji 822A, as shown in FIG. 8H (e.g., without automatically sending the message). Subsequently, computer system 600 detects input 850D (e.g., a tap input and/or a tap-and-hold input) directed to send option 822 and, in response, computer system 600 transmits a message that includes emoji 822A and emoji 822B as part of message conversation 826, as shown in FIG. 8I. In some embodiments, in response to detecting input 850D, computer system 600 displays message conversation 826, as shown in FIG. 8I. Message conversation 826 includes an earlier message 826A from a remote participant and the new message 826B that includes emoji 822A and emoji 822B.

FIG. 9 is a flow diagram illustrating a method for outputting information about a real-world object using a computer system, in accordance with some embodiments. Method 700 is performed at a computer system (e.g., 100, 300, 500, and/or 600) (e.g., a smartphone, a desktop computer, a laptop, a tablet, a wearable device (e.g., a smart watch or a wearable fitness tracker), a head-mounted device, and/or a projection-based system) that is in communication with one or more input devices (e.g., a camera (e.g., an infrared camera, a depth camera, a visible light camera, and/or a gaze tracking camera), a gyroscope, an accelerometer, a mouse, a trackpad, and/or a physiological sensor (e.g., a blood pressure sensor and/or a heart rate sensor)) that include one or more cameras (e.g., 620) (e.g., infrared camera(s) and/or visible light camera(s)) and one or more output devices (e.g., a display generation component and/or an audio output device (e.g., a speaker and/or an audio output circuit)) that include one or more display generation components (e.g., 602) (e.g., a head-mounted display system, a display (e.g., a touch-sensitive display), a projector, a 3D display, a display having at least a portion that is transparent or translucent on which images can be projected (such as, e.g., a see-through display), a heads-up display, and/or a display controller). In some embodiments, the one or more input devices are integrated into the computer system. In some embodiments, the one or more input devices are integrated into an external device (e.g., a wearable device) that is in communication with the computer system. Some operations in method 900 are, optionally, combined, the orders of some operations are, optionally, changed, and some operations are, optionally, omitted.

As described below, method 900 provides an intuitive way for outputting information about a real-world object. The method reduces the cognitive burden on a user for access information about real-world objects, thereby creating a more efficient human-machine interface. For battery-operated computing devices, enabling a user to access information about real-world objects faster and more efficiently conserves power and increases the time between battery charges.

While (902) not displaying, via the one or more display generation components (e.g., 602) (e.g., without displaying via any display generation component), a camera feed (e.g., a live camera feed and/or a delayed camera feed) based on (e.g., using and/or of) the one or more cameras (e.g., 620), the computer system (e.g., 600) receives (904), via the one or more input devices (e.g., via the one or more cameras and/or via a different input device), a request (e.g., 850A) to scan a real-world object (e.g., 860, 850B, 850C, 860, and/or 862) (e.g., a physical item in the real-world (e.g., physical environment)).

While (902) not displaying, via the one or more display generation components (e.g., 602) (e.g., without displaying via any display generation component), a camera feed (e.g., a live camera feed and/or a delayed camera feed) based on (e.g., using and/or of) the one or more cameras (e.g., 620) and in response to (906) receiving the request to scan the real-world object, the computer system (e.g., 600) scans (908) (e.g., collecting information about and/or collecting visual information about) (e.g., in color, in black and white, along one dimension, along two dimensions, and/or along three dimensions) (e.g., without emitting a light for the scanning), via the one or more input devices (e.g., 602), the real-world object (e.g., 860, 850B, 850C, 860, 862, and/or 864) (and, optionally, identifying the real-world object) and the computer system (e.g., 600) outputs (910), via the one or more output devices (e.g., 602 and/or an audio output device/speaker) (e.g., via the one or more display generation components and/or via a different input device), information (e.g., 804A, 804B, 804C, 822A, 822B, 870A, and/or 870B) (e.g., via visual output, haptic output, and/or audio output) about the real-world object (e.g., information determined and/or identified based on scanning the real-world object). Outputting information about a real-world object that is scanned provides the user with data about what real-world object the computer system has detected, thereby providing the user with improved feedback about the state of the computer system.

In some embodiments, scanning the real-world object (e.g., 860) includes scanning a machine-readable optical image (e.g., 860A) (e.g., a two-dimensional matrix barcode, QR code, and/or a barcode). In some embodiments, the machine-readable optical image corresponds to (and/or identifies) the real-world object. In some embodiments, the machine-readable optical image is part of (e.g., printed on or affixed to) the real-world object. Outputting information about a real-world object that is scanned using a QR code provides the user with data about what real-world object the computer system has detected, thereby providing the user with improved feedback.

In some embodiments, outputting information (e.g., via visual output, haptic output, and/or audio output) about the real-world object (e.g., 860) includes outputting allergy information (e.g., 804C and/or 804E) corresponding to the real-world object (e.g., allergens included in the real-world object). In some embodiments, the real-world object is a food (e.g., a packaged food) and the information output includes information about allergens (e.g., milk, eggs, fish, Crustacean shellfish, tree nuts, peanuts, wheat, and/or soybeans) in the food. In some embodiments, the information about is retrieved from a (local and/or remote) nutrition database. Outputting allergy information about a real-world object that is scanned provides the user with data about what allergens the real-world object includes, thereby providing the user with the ability to avoid potential allergens.

In some embodiments, outputting information (e.g., via visual output, haptic output, and/or audio output) about the real-world object (e.g., 860) includes outputting (e.g., visual output and/or audio output) one or more nutrition scores (e.g., 804D) corresponding to the real-world object (e.g., 860) (e.g., allergens included in the real-world object). In some embodiments, the real-world object is a food (e.g., a packaged food) and the information output includes information about a nutrition score (e.g., on a scale of 0-100) of the food. In some embodiments, the information about is retrieved from a (local and/or remote) nutrition database. Outputting nutrition information about a real-world object that is scanned provides the user with data about the nutrition of the real-world object, thereby providing the user with improved feedback.

In some embodiments, in response to receiving the request to scan the real-world object (e.g., 860), the computer system logs (e.g., automatically or based on input directed to 804A) nutrition information corresponding to the real-world object. In some embodiments, the real-world object is a food and the computer system logs nutrition information, such as calories, nutrients, and/or allergens, of the food. Logging nutrition information about real-world object allows the computer system to store information about scanned items, thereby making the information accessible at a later time. Logging nutrition information also reduces the number of inputs required to log information about the real-world object.

In some embodiments, scanning the real-world object includes scanning a machine-readable optical image (e.g., barcode 860A and/or a QR code) (e.g., a two-dimensional matrix barcode, QR code, and/or a barcode) corresponding to a transaction (e.g., a transfer of images and/or a transfer of funds). In some embodiments, the machine-readable optical image identifies a recipient of the funds and/or an amount of the funds. Scanning a code that corresponds to a transaction enables the computer system to participant in the transaction, thereby reducing the need for the user to manually enter transaction information. Scanning a code that corresponds to a transaction also reduces the number of inputs required to enter transaction information into the computer system.

In some embodiments, scanning the real-world object (e.g., 862 and/or 864) includes scanning text (e.g., 862A and/or 864A) and wherein outputting information about the real-world object includes outputting audio information (e.g., 870A and/or 870B) (e.g., via a speaker, via a headset, via an audio output device) of the text (e.g., using text-to-speech). Reading content aloud provides the user with audio feedback about the content that was scanned, thereby providing improved feedback. Reading the content aloud also enables visually impaired users to access written content.

In some embodiments, scanning the real-world object includes scanning text (e.g., 864A) of a first language and wherein outputting information about the real-world object includes outputting (e.g., via a display, via a speaker, via a headset, via an audio output device) a translation (e.g., 870B) of the text in a second language that is different from the first language. Translating content enables the computer system to scan content in one language and output a translation in a different language that the user understands, enabling the user to access the content.

In some embodiments, scanning the real-world object (e.g., 862 and/or 864) includes copying content (e.g., 862A and/or 864A) of (e.g., text, images of, a color of) the real-world object (and, optionally, storing the copied content locally or remotely). In some embodiments, the real-world object is an object that has text and copying the content includes copying the text. In some embodiments, the computer system receives a request to paste the copied content and, in response, the computer system pastes the copied content into a field (e.g., a text field) of an application of the computer system.

Copying the content enables the computer system (and therefore the user) to access the copied content at a later time, thereby reducing the need for the user to manually enter the content into the computer system and improving the man-machine interface.

In some embodiments, scanning the real-world object (e.g., 862 and/or 864) includes saving content (e.g., 862A and/or 864A) of (e.g., text, images of, a color of) the real-world object (e.g., locally or remotely). In some embodiments, the real-world object is an object that has text and copying the content includes copying the text. Saving the content enables the computer system (and therefore the user) to access the saved content at a later time, thereby reducing the need for the user to rescan the content into the computer system and improving the man-machine interface.

In some embodiments, scanning the real-world object includes capturing a pose (e.g., 850B and/or 850C) of a portion of a body of a user (e.g., 660). In some embodiments, the portion of the body of the user is an expression of the user (e.g., via a face, a mouth, and/or eyes of the user). In some embodiments, the portion of the body of the user is a hand of the user. Capturing a post of the user enables the computer system to receive pose information without requiring additional user inputs (e.g., no need to enter information on a keyboard of the computer system), thereby providing an improved input user interface.

In some embodiments, in accordance with (e.g., in response to) a determination that the captured pose (e.g., 850B) of the portion of the body of the user (e.g., 660) is a first pose (e.g., 850B), the computer system (e.g., 600) selects a first emoji (e.g., 822A) (e.g., to be inserted into a conversation and/or an entry field); and in accordance with (e.g., in response to) a determination that the captured pose (e.g., 850C) of the portion of the body of the user (e.g., 660) is a second pose (e.g., 850C) that is different from the first pose (e.g., 850B), the computer system (e.g., 600) selects a second emoji (e.g., 822B) (e.g., to be inserted into a conversation and/or an entry field) that is different from the first emoji (e.g., 822A). In some embodiments, the computer system selects, based on the captured pose of the portion of the body of the user, an emoji (e.g., that corresponds to the captured pose). In some embodiments, a captured pose of smiling results in selecting a smiling emoji. In some embodiments, a captured pose of a thumbs up results in selecting a thumbs up emoji. In some embodiments, the emoji is inserted (e.g., automatically) into a text entry field of a communication application (e.g., an instant messaging or emailing application). Selecting an emoji based on the captured pose enables the computer system to quickly select a user-desired emoji without requiring additional user inputs (e.g., no need to enter information on a keyboard of the computer system), thereby providing an improved input user interface.

In some embodiments, outputting the information about the real-world object includes: in accordance with (e.g., in response to) a determination that the captured pose of the portion of the body of the user (e.g., 660) is a first pose (e.g., 850B), the computer system (e.g., 600) selects a first animated object (e.g., an animated emoji, such as a heart that is beating, or an animated digital sticker (e.g., that can be placed in various positions of an image of video)); and in accordance with (e.g., in response to) a determination that the captured pose of the portion of the body of the user (e.g., 660) is a second pose (e.g., 850C) that is different from the first pose (e.g., 850B), the computer system (e.g., 600) selects a second animated object (e.g., 822B) (e.g., an animated emoji, such as a heart that is beating, or an animated digital sticker (e.g., that can be placed in various positions of an image of video)) that is different from the first animated object (e.g., 822A). In some embodiments, the computer system selects, based on the captured pose of the portion of the body of the user, an animated object (e.g., an animated emoji, such as a heart that is beating, or an animated digital sticker (e.g., that can be placed in various positions of an image of video)). In some embodiments, a captured pose of smiling results in selecting an animated smiling emoji. In some embodiments, a captured pose of a thumbs up results in selecting an animated thumbs up emoji. In some embodiments, the animated emoji is inserted (e.g., automatically) into a text entry field of a communication application (e.g., an instant messaging or emailing application). Selecting an animated object based on the captured pose enables the computer system to quickly select a user-desired animated object without requiring additional user inputs (e.g., no need to enter information on a keyboard of the computer system), thereby providing an improved input user interface.

In some embodiments, the computer system (e.g., 600) transmits (e.g., subsequent to outputting information (e.g., via visual output, haptic output, and/or audio output) about the real-world object) (e.g., automatically and/or in response to user input, such as a user input selecting a send option) a response (e.g., 826B) in a conversation (e.g., 826) (e.g., an instant messaging conversation and/or an email conversation) using (e.g., including and/or based on) the information (e.g., 822A and/or 822B). In some embodiments, outputting information (e.g., via visual output, haptic output, and/or audio output) about the real-world object includes using the information to respond in a conversation (e.g., an instant messaging conversation and/or an email conversation). In some embodiments, the information about the real-world object is automatically inserted into a reply field of the conversation. In some embodiments, the information about the real-world object is automatically copied into memory of the computer system and, in response to detecting a paste command, the information is pasted into a field (e.g., a reply field) of the conversation. Using the information to respond in a conversation allows the user to quickly enter information as a response, without the need to provide additional information (e.g., keyboard inputs) to select the response, thereby providing an improved input user interface.

Note that details of the processes described above with respect to method 900 (e.g., FIG. 9) are also applicable in an analogous manner to the methods described below. For example, method 700 optionally includes one or more of the characteristics of the various methods described above with reference to method 900. For example, the same input device is used for user presence detection as for object detection. For another example, the computer systems are the same. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to perform actions based on user presence and/or output information about detected objects. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. Accordingly, use of such personal information data enables users to have calculated control of the presence/object detection.

Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of object detection, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.
1-60. (canceled)

61. A computer system configured to communicate with one or more input devices and one or more display generation components, comprising:
one or more processors; and
memory storing one or more programs configured to be executed by the one or more processors, the one or more programs including instructions for:
while displaying, via the one or more display generation components, a user interface:
in accordance with a determination that a first set of one or more conditions is met, the first set of one or more conditions including a presence not detected condition that is met when a user presence at the computer system is not detected via the one or more input devices:
displaying, via the one or more display generation components, a first user interface object; and/or
ceasing display, via the one or more display generation components, of a second user interface object.

62. The computer system of claim 61, the one or more programs further including instructions for:
while displaying, via the one or more display generation components, the user interface:
in accordance with a determination that a second set of one or more conditions is met, the second set of one or more conditions including a presence detected condition that is met when a user presence at the computer system is detected via the one or more input devices:
displaying, via the one or more display generation components, a third user interface object; and/or
ceasing display, via the one or more display generation components, of a fourth user interface object.

63. The computer system of claim 61, wherein the computer system is a wearable device and wherein the computer system is being worn when the presence not detected condition is met.

64. The computer system of claim 61, wherein the first set of one or more conditions includes a proximity condition that is based on proximity of a user to the computer system.

65. The computer system of claim 64, wherein the proximity condition is based on proximity to a display of the computer system.

66. The computer system of claim 61, wherein the one or more input devices includes a visual sensor and wherein user presence at the computer system is detected and/or not detected via the visual sensor.

67. The computer system of claim 66, wherein the visual sensor is an under-display visual sensor.

68. The computer system of claim 61, wherein user presence at the computer system is not detected via the one or more input devices based on a failure to detect a face via the one or more input devices.

69. The computer system of claim 61, the one or more programs further including instructions for:
detecting movement of the computer system; and
in response to detecting the movement of the computer system, activating a visual sensor of the one or more input devices to capture visual data using the visual sensor, wherein the visual data is used to determine user presence.

70. The computer system of claim 61, the one or more programs further including instructions for:
detecting user input; and
in response to detecting the user input, transitioning the computer system from a first power mode to a second power mode that is different from the first power mode.

71. The computer system of claim 61, wherein:
the first user interface object is a complication of a watch face; and
the second user interface object is a complication of the watch face.

72. The computer system of claim 61, the one or more programs further including instructions for:
in accordance with the determination that the first set of one or more conditions is met, changing a displayed size of a current time.

73. The computer system of claim 61, the one or more programs further including instructions for:
in accordance with the determination that the first set of one or more conditions is met, changing a configuration of a displayed current time.

74. The computer system of claim 61:
wherein the first user interface object is a complication and the second user interface object is a display of a current time; and
wherein displaying the first user interface object and ceasing display of the second user interface object includes replacing display of the complication with a display of the current time.

75. The computer system of claim 61, wherein ceasing display of the second user interface object includes ceasing display of first information of a complication while maintaining display of second information of the complication.

76. The computer system of claim 61, the one or more programs further including instructions for:
displaying, via the one or more display generation components, an animation of an objection based on user presence being detected.

77. The computer system of claim 61, the one or more programs further including instructions for:
in accordance with the determination that the first set of one or more conditions is met, modifying a background of the user interface.

78. The computer system of claim 61, wherein the presence not detected condition is met when a face is not detected at the computer system via the one or more input devices.

79. The computer system of claim 78, the one or more programs further including instructions for:
animating over time a user interface object based on a proximity of a face detected via the one or more input devices.

80. The computer system of claim 61, wherein the first set of one or more conditions includes a touch not detected condition that is met when a touch input is not detected via the one or more input devices.

81. The computer system of claim 61, wherein a first change applied to the user interface based on a first presence-based state is reversed based on a second presence-based state that is different from the first presence-based state.

82. The computer system of claim 61, the one or more programs further including instructions for:
detecting, via the one or more input devices, movement of a user relative to the computer system; and
in response to detecting the movement of the user relative to the computer system, animating a change, via the one or more display generation components, of the user interface, wherein the change is based on the movement of the user relative to the computer system.

83. The computer system of claim 82, wherein the movement of the user relative to the computer system includes movement of eyes of the user.

84. The computer system of claim 82, wherein animating the change of the user interface includes animating a simulated parallax effect.

85. The computer system of claim 82, wherein animating the change of the user interface includes animating a character.

86. The computer system of claim 82, wherein the movement of the user relative to the computer system is based on a position of a face of the user and/or left-right movement of the face of the user.

87. The computer system of claim 61, the one or more programs further including instructions for:
scrolling content based on a user presence being detected at the computer system.

88. The computer system of claim 61, the one or more programs further including instructions for:
scrolling content based on a gaze of a user of the computer system.

89. The computer system of claim 88, wherein scrolling content based on the gaze of the user of the computer system includes:
in accordance with a determination that the gaze is directed to the computer system, the computer system scrolls content; and
in accordance with a determination that the gaze is not directed to the computer system, the computer system forgoes scrolling the content.

90. The computer system of claim 88, wherein scrolling content based on a gaze of the user of the computer system includes:
in accordance with a set of one or more scroll conditions being met, wherein the set of one or more scroll conditions include a gaze condition that is met when a gaze of the user is directed to the computer system and a confirmation condition that is met when a confirmation input is received, the computer system scrolls content.

91. A non-transitory computer-readable storage medium storing one or more programs configured to be executed by one or more processors of a computer system that is in communication with one or more input devices and one or more display generation components, the one or more programs including instructions for:
while displaying, via the one or more display generation components, a user interface:
in accordance with a determination that a first set of one or more conditions is met, the first set of one or more conditions including a presence not detected condition that is met when a user presence at the computer system is not detected via the one or more input devices:
displaying, via the one or more display generation components, a first user interface object; and/or
ceasing display, via the one or more display generation components, of a second user interface object.

92. A method, comprising:
at a computer system that is in communication with one or more input devices and one or more display generation components:
while displaying, via the one or more display generation components, a user interface:
in accordance with a determination that a first set of one or more conditions is met, the first set of one or more conditions including a presence not detected condition that is met when a user presence at the computer system is not detected via the one or more input devices:
displaying, via the one or more display generation components, a first user interface object; and/or
ceasing display, via the one or more display generation components, of a second user interface object.
